(19) United States
(12) Patent Application Publication
(10) Pub. No.: US 2022/0214550 A1
(43) Pub. Date: Jul. 7, 2022

(54) IMAGE DISPLAY APPARATUS AND DISPLAY APPARATUS

(71) Applicant: SONY GROUP CORPORATION, TOKYO (JP)

(72) Inventor: AKIO MACHIDA, TOKYO (JP)

(21) Appl. No.: 17/613,374

(22) PCT Filed: Apr. 15, 2020
(86) PCT No.: PCT/JP2020/016631

§ 371 Date: Nov. 22, 2021

(30) Foreign Application Priority Data
May 31, 2019 (JP) 2019-102134

(51) Int. Cl. G02B 27/01; G02B 6/26

(52) U.S. Cl. CPC G02B 27/0172; G02B 27/0176; G02B 6/26; G02B 2027/0132; G02B 2027/0152; G02B 2027/0123; G02B 2027/0178

(57) ABSTRACT

A display apparatus includes a frame 10, a right-eye image display apparatus 20R, and a left-eye image display apparatus 20L, each of the image display apparatuses including an image forming apparatus 30 and an optical apparatus 40, the optical apparatus 40 including a light guiding plate 41, a first deflection mechanism 42, and a second deflection mechanism 43, in which an image coming from the image forming apparatus 30 enters the first deflection mechanism 42, is deflected by the first deflection mechanism 42, is guided through the light guiding plate 41, enters the second deflection mechanism 43, is deflected by the second deflection mechanism 43, and enters a pupil 51 of an observer 50; and an image that is formed by the right-eye image display apparatus 20R and an image that is formed by the left-eye image display apparatus 20L are not fused with each other.

### TECHNICAL FIELD

The present disclosure relates to a display apparatus and an image display apparatus that is suitable for use in the display apparatus, and in particular to a display apparatus that is used for a head-mounted display (HMD), and an image display apparatus that is suitable for use in the display apparatus.

### BACKGROUND ART

In recent years, an augmented reality (AR) technology that combines, as additional information, a virtual object and various information with a real environment (or a portion thereof) to obtain electronic information, and presents the electronic information has attracted attention. For example, a see-through (semi-transmissive) head-mounted display has been discussed as an apparatus used to present visual information, in order to provide such an augmented reality technology. Further, regarding the field of application, the augmented reality technology is expected to support various operations in a real environment, and examples of the field of application include provision of directional guide information, and provision of technical information to an engineer who is involved in, for example, maintenance. In particular, a head-mounted display is very useful since the hands can be used. Further, due to a see-through head-mounted display, a user can capture various information or the like that is a video or an image, and an external environment at the same time in the field of view when the user obtains the various information or the like while moving outdoors. This enables the user to move smoothly.

A virtual-image display apparatus (a display apparatus) used to cause an observer to observe a two-dimensional image in the form of a magnified virtual image using a virtual-image optical system is known, the two-dimensional image being formed by an image forming apparatus. The virtual-image display apparatus (the display apparatus) is disclosed in, for example, WO2014/168010A1. The display apparatus includes
(1) a frame and
(2) a left-eye image display apparatus and a right-eye image display apparatus that are attached to the frame. Further, each of the image display apparatuses includes
(A) an image forming apparatus and
(B) an optical system that guides an image coming from the image forming apparatus to a pupil of an observer,
the optical system including a reflecting mirror and a lens group, the reflecting mirror being a reflecting mirror off which the image coming from the image forming apparatus is reflected, the lens group being arranged between the pupil of the observer and the reflecting mirror, the lens group being a lens group that the image reflected off the reflecting mirror enters, in which
a normal line of the reflecting mirror included in the optical system of the left-eye image display apparatus and a normal line of the reflecting mirror included in the optical system of the right-eye image display apparatus intersect in a space situated across the reflecting mirror from the observer. Here, light that exits the image forming apparatus, travels downward and toward a nose of the observer, is reflected off the reflecting mirror, passes through the lens group, and travels on an optical axis of the lens group enters the pupil of the observer from a position closer to an ear of the observer than an optical axis of the pupil of the observer, the ear of the observer being situated on the same side as the pupil of the observer. Such a configuration makes it possible to obtain a wider angle of view for an image, such as a viewing angle with a single eye (100 degrees), a viewing angle with both eyes (70 degrees), and a total horizontal viewing angle (130 degrees).

### CITATION LIST

### Patent Literature

Patent Literature 1: WO02014/168010A1

### DISCLOSURE OF INVENTION

### Technical Problem

The see-through head-mounted display makes it possible to capture various information or the like that is a video or an image, and an external environment at the same time in the field of view. As illustrated in FIG. 13B, the various information or the like is normally displayed in a center portion of the field of view. Then, an image formed by a right-eye image display apparatus and an image formed by a left-eye image display apparatus are fused. In other words, information is displayed to block the field of view. Display of information without blocking the field of view is strongly desired. In order to fulfil such a desire, there is a need to display information at both ends of the field of view. Further, there is a need for a wider angle of view for an image to achieve such a display. However, it is currently difficult to obtain a wider angle of view for an image using a lightweight see-through head-mounted display. Due to a wider angle of view for an image being obtained, the see-through head-mounted display may be made heavier and may become unshapely. For example, the angle of view of a lightweight see-through head-mounted display with respect to horizontal display is at most 20 degrees.

Thus, it is an object of the present disclosure to provide a display apparatus that is not made heavier in weight, and can display thereon information without blocking the field of view, and an image display apparatus that is included in the display apparatus.

### Solution to Problem

In order to achieve the object described above, display apparatuses according to first and second aspects of the present disclosure are binocular display apparatuses, each display apparatus including
a frame; and
a right-eye image display apparatus and a left-eye image display apparatus that are attached to the frame,
each of the image display apparatuses including
   an image forming apparatus, and
   an optical apparatus that guides an image coming from the image forming apparatus to a pupil of an observer,
the optical apparatus including
   a light guiding plate,
   a first deflection mechanism that is attached to the light guiding plate, and
   a second deflection mechanism that is attached to the light guiding plate, in which
the image coming from the image forming apparatus enters the first deflection mechanism, is deflected by the first deflection mechanism, is guided through the light guiding plate, enters the second deflection mechanism, is deflected by the second deflection mechanism, and enters the pupil of the observer.

Further, in the display apparatus according to the first aspect of the present disclosure, when a central ray that exits from a center point of an image forming region in the image forming apparatus, is deflected by the second deflection mechanism to enter the pupil of the observer, and when a point, on the light guiding plate, at which the central ray exits the light guiding plate is an origin, and when, in an XYZ orthogonal coordinate system of which axes of X, Y, and Z pass through the origin, an axis of the light guiding plate that passes through the origin is an X axis, an axis that passes through the origin and extends in parallel with a normal line of the light guiding plate is a Z axis, and an axis that is orthogonal to the X and Z axes is a Y axis, the central ray enters from a position closer to the image forming apparatus than an imaginary vertical plane that includes a pupillary axis and is parallel to the Y axis. Note that the pupillary axis is defined as a line that passes through the center of an entrance pupil of an eye and is orthogonal to a corneal surface.

Further, in the display apparatus according to the second aspect of the present disclosure, an image that is formed by the right-eye image display apparatus and an image that is formed by the left-eye image display apparatus are not fused with each other. Note that the fusion refers to a phenomenon in which images respectively falling upon retinae of right and left eyes are fused to be recognized as one image.

In order to achieve the object described above, a display apparatus according to a third aspect of the present disclosure is a monocular display apparatus, the display apparatus including
a frame; and
an image display apparatus that is attached to the frame,
the image display apparatus including
   an image forming apparatus, and
   an optical apparatus that guides an image coming from the image forming apparatus to a pupil of an observer,
the optical apparatus including
   a light guiding plate,
   a first deflection mechanism that is attached to the light guiding plate, and
   a second deflection mechanism that is attached to the light guiding plate, in which
the image coming from the image forming apparatus enters the first deflection mechanism, is deflected by the first deflection mechanism, is guided through the light guiding plate, enters the second deflection mechanism, is deflected by the second deflection mechanism, and enters the pupil of the observer, and
when a central ray that exits from a center point of an image forming region in the image forming apparatus, is deflected by the second deflection mechanism to enter the pupil of the observer, and when a point, on the light guiding plate, at which the central ray exits the light guiding plate is an origin, and when, in an XYZ orthogonal coordinate system of which axes of X, Y, and Z pass through the origin, an axis of the light guiding plate that passes through the origin is an X axis, an axis that passes through the origin and extends in parallel with a normal line of the light guiding plate is a Z axis, and an axis that is orthogonal to the X and Z axes is a Y axis, the central ray enters from a position closer to the image forming apparatus than an imaginary vertical plane that includes a pupillary axis and is parallel to the Y axis.

In order to achieve the object described above, an image display apparatus of the present disclosure includes
an image forming apparatus; and
an optical apparatus that guides an image coming from the image forming apparatus to a pupil of an observer,
the optical apparatus including
   a light guiding plate,
   a first deflection mechanism that is attached to the light guiding plate, and
   a second deflection mechanism that is attached to the light guiding plate, in which
the image coming from the image forming apparatus enters the first deflection mechanism, is deflected by the first deflection mechanism, is guided through the light guiding plate, enters the second deflection mechanism, is deflected by the second deflection mechanism, and enters the pupil of the observer, and
when a central ray that exits from a center point of an image forming region in the image forming apparatus, is deflected by the second deflection mechanism to enter the pupil of the observer, and when a point, on the light guiding plate, at which the central ray exits the light guiding plate is an origin, and when, in an XYZ orthogonal coordinate system of which axes of X, Y, and Z pass through the origin, an axis of the light guiding plate that passes through the origin is an X axis, an axis that passes through the origin and extends in parallel with a normal line of the light guiding plate is a Z axis, and an axis that is orthogonal to the X and Z axes is a Y axis, the central ray enters from a position closer to the image forming apparatus than an imaginary vertical plane that includes a pupillary axis and is parallel to the Y axis.

### BRIEF DESCRIPTION OF DRAWINGS

FIG. 1A schematically illustrates a display apparatus of a first embodiment, as viewed from the front, and FIG. 1B schematically illustrates the display apparatus of the first embodiment, as viewed from the lateral side.

FIG. 2 schematically illustrates the display apparatus of the first embodiment, as viewed from above.

FIG. 3 is a schematic diagram illustrating an observer, as viewed from above, that is used to describe a positional relationship between an optical apparatus that is included in a binocular display apparatus of the first embodiment and a pupil of the observer.

FIG. 4 is a schematic diagram illustrating the observer, as viewed from above, that is used to describe a positional relationship between an optical apparatus that is included in a monocular display apparatus of the first embodiment and the pupil of the observer.

FIG. 5 is a schematic diagram illustrating the observer, as viewed from above, that is used to describe the positional relationship between the optical apparatus included in the monocular display apparatus of the first embodiment and the pupil of the observer.

FIGS. 6A and 6B are schematic cross-sectional views of the optical apparatus and the like, as viewed from above, that are used to describe a positional relationship between the optical apparatus included in the display apparatus of the first embodiment and the pupil of the observer.

FIG. 7 is an enlarged portion of the schematic cross-sectional view of FIG. 6A illustrating a portion of the optical apparatus and the like, as viewed from above, the portion of the optical apparatus including a second deflection mechanism.

FIG. 8 is an enlarged portion of the schematic cross-sectional view of FIG. 6A illustrating a portion of the optical apparatus and the like, as viewed from above, the portion of the optical apparatus including a first deflection mechanism.

FIG. 9 is an enlarged portion of the schematic cross-sectional view of FIG. 6A illustrating a modification of the portion of the optical apparatus and the like, as viewed from above, the portion of the optical apparatus including the second deflection mechanism.

FIGS. 10A and 10B are schematic cross-sectional views of the optical apparatus and the like, as viewed from above, that are used to describe the positional relationship between the optical apparatus included in the display apparatus of the first embodiment and the pupil of the observer.

FIGS. 11A and 11B are schematic cross-sectional views of the optical apparatus and the like, as viewed from above, that are used to describe the positional relationship between the optical apparatus included in the display apparatus of the first embodiment and the pupil of the observer.

FIGS. 12A and 12B are schematic cross-sectional views of the optical apparatus and the like, as viewed from above, that are used to describe the positional relationship between the optical apparatus included in the display apparatus of the first embodiment and the pupil of the observer.

FIG. 13A schematically illustrates a state of viewing the outside world and a displayed image using the display apparatus of the first embodiment, and FIG. 13B schematically illustrates a state of viewing the outside world and the displayed image using a conventional display apparatus.

FIG. 14 schematically illustrates the arrangement of an image forming apparatus and the optical apparatus being included in the display apparatus of a second embodiment.

FIG. 15A is a schematic cross-sectional view of an enlarged portion of a reflective volume-hologram diffraction grating layer, and FIG. 15B schematically illustrates the image forming apparatus included in a modification of the display apparatus of the second embodiment.

FIG. 16 schematically illustrates the arrangement of the image forming apparatus and the optical apparatus being included in the display apparatus of a third embodiment.

FIG. 17 schematically illustrates the arrangement of the image forming apparatus and the optical apparatus being included in the display apparatus of a fourth embodiment.

FIG. 18 schematically illustrates the arrangement of the image forming apparatus and the optical apparatus being included in a modification of the display apparatus of the fourth embodiment.

FIG. 19A is a schematic cross-sectional view of a light adjusting apparatus, and FIG. 19B is a schematic front view of a modification of the light adjusting apparatus.

FIG. 20A is a schematic cross-sectional view of another modification of the light adjusting apparatus, and FIG. 20B is a schematic front view of the other modification of the light adjusting apparatus.

FIG. 21 schematically illustrates a modification of the optical apparatus included in the display apparatus illustrated in the second or third embodiment.

FIG. 22 schematically illustrates another modification of the optical apparatus included in the display apparatus illustrated in the second or third embodiment.

FIG. 23 is a conceptual diagram of yet another modification of the optical apparatus included in the display apparatus illustrated in the second or third embodiment.

FIGS. 24A to 24F are conceptual diagrams of yet other modifications of the optical apparatus included in the display apparatuses of the second and third embodiments.

FIG. 25 schematically illustrates yet another modification of the optical apparatus included in the display apparatus illustrated in the second or third embodiment.

FIGS. 26A and 26B are conceptual diagrams used to describe an angle 2β formed by a first-light-ray orthogonal projection image and a second-light-ray orthogonal projection image.

FIG. 27 is a conceptual diagram used to describe a method for evaluating a state in which there is a difference in slant angle in the second deflection mechanism of the optical apparatus.

FIG. 28 is a conceptual diagram used to describe the method for evaluating the state in which there is a difference in slant angle in the second deflection mechanism of the optical apparatus.

FIGS. 29A and 29B are schematic cross-sectional views of the optical apparatus and the like, as viewed from above, that are used to describe a positional relationship between the optical apparatus included in a conventional display apparatus and the pupil of the observer.

### MODE(S) FOR CARRYING OUT THE INVENTION

The present disclosure is described below on the basis of embodiments with reference to the drawings. However, the present disclosure is not limited to the embodiments, and various numerical values and materials in the embodiments are merely illustrative. Note that the description is made in the following order.
1. General Descriptions of Display Apparatuses According to First to Third Aspects of Present Disclosure, and Image Display Apparatus of Present Disclosure
2. First Embodiment (Display Apparatuses According to First to Third Aspects of Present Disclosure, and Image Display Apparatus of Present Disclosure)
3. Second Embodiment (Image Display Apparatus and Optical Apparatus That are Included in Display Apparatus of First Embodiment)
4. Third Embodiment (Modification of Second Embodiment)
5. Fourth Embodiment (Modification of Second and Third Embodiments)
6. Fifth Embodiment (Modification of First to Fourth Embodiments, Light Adjusting Apparatus)
7. Others

<General Descriptions of Display Apparatuses According to First to Third Aspects of Present Disclosure, and Image Display Apparatus of Present Disclosure>

In display apparatuses according to first to third aspects of the present disclosure, or in an image display apparatus of the present disclosure, a light ray that enters a region, in a first deflection mechanism, that is situated on the side of an ear of an observer exits a region, in a second deflection mechanism, that is situated on the side of a nose of the observer, and a light ray that enters a region, in the first deflection mechanism, that is situated on the side of the nose of the observer exits a region, in the second deflection mechanism, that is situated on the side of the ear of the observer. A central ray enters the center of a pupil of the observer. Regarding a light guiding plate, an X axis represents a longitudinal direction of the light guiding plate (the horizontal direction), a Y axis represents a width direction of the light guiding plate (the height direction or the vertical direction), and a Z axis represents a thickness direction of the light guiding plate.

In the display apparatuses according to the first to third aspects of the present disclosure, α>0 degrees, favorably α≥5 degrees, and more favorably α≥10 degrees may be satisfied when α is an angle formed by a pupillary axis and an orthogonal projection image obtained by orthogonally projecting a central ray onto an XZ plane.

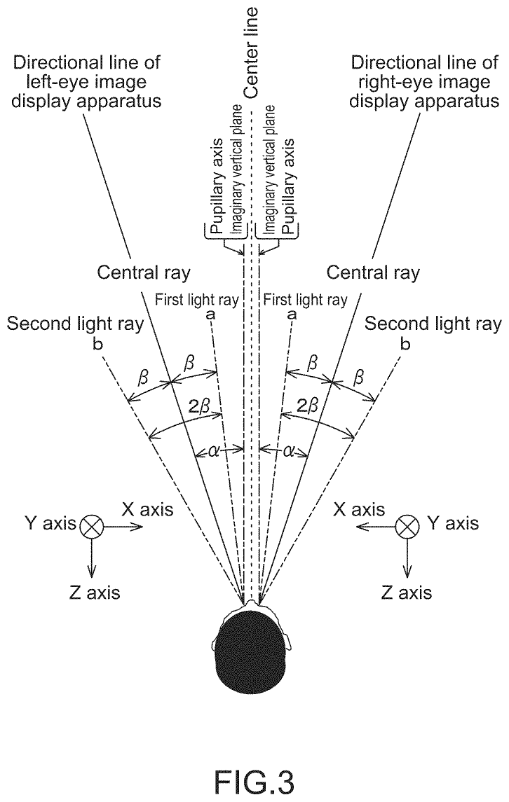

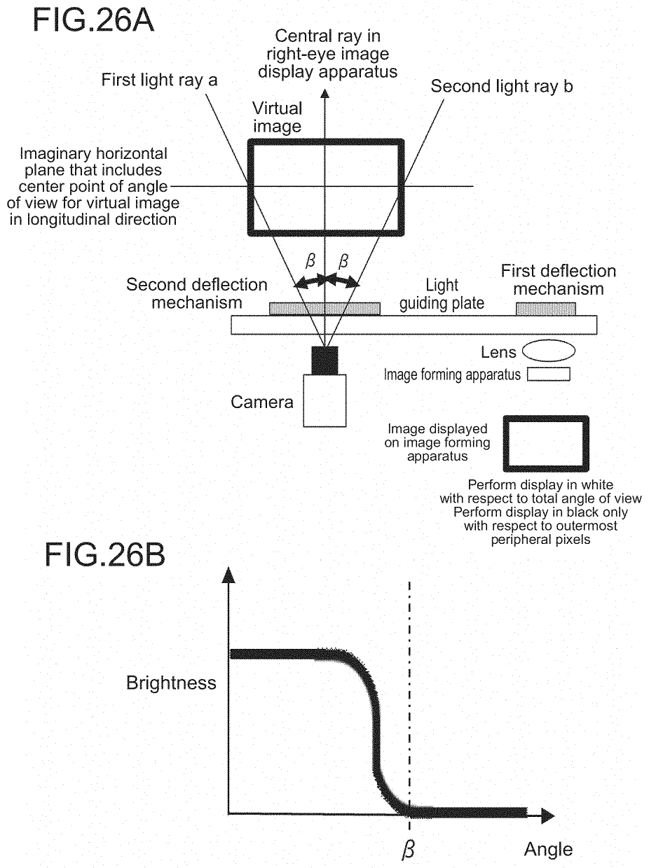

In the display apparatuses according to the first and second aspects of the present disclosure including the favorable configuration described above,
it is favorable that α>β be satisfied when 2β is an angle formed by a first-light-ray orthogonal projection image and a second-light-ray orthogonal projection image, the first-light-ray orthogonal projection image being obtained by orthogonally projecting a first light ray onto the XZ plane, the first light ray exiting an ear-side end of the image forming apparatus that is situated in an imaginary XZ plane in the image forming apparatus, and entering the pupil of the observer, the imaginary XZ plane corresponding to the XZ plane, the second-light-ray orthogonal projection image being obtained by orthogonally projecting a second light ray onto the XZ plane, the second light ray exiting a nose-side end of the image forming apparatus that is situated in the imaginary XZ plane, and entering the pupil of the observer (refer to FIG. 3). Here, as illustrated in FIG. 26A, the angle 2β corresponds to a maximum angle of view for a virtual image displayed on an imaginary horizontal plane that includes a center point of the angle of view for the virtual image in a longitudinal direction, the virtual image being formed by the image display apparatus. Specifically, in the entirety of the image forming apparatus, display is performed in white with respect to the total angle of view, and display is performed in black only with respect to a portion corresponding to outermost peripheral pixels. A camera is arranged at the position of the pupil to capture an image, and an angle at which the brightness of the image (refer to FIG. 26B) is lowest is obtained. Accordingly, the angle 2β can be obtained. The adoption of such a configuration makes it possible to more certainly prevent the occurrence of a phenomenon in which an image formed by a right-eye image display apparatus and an image formed by a left-eye image display apparatus are fused.

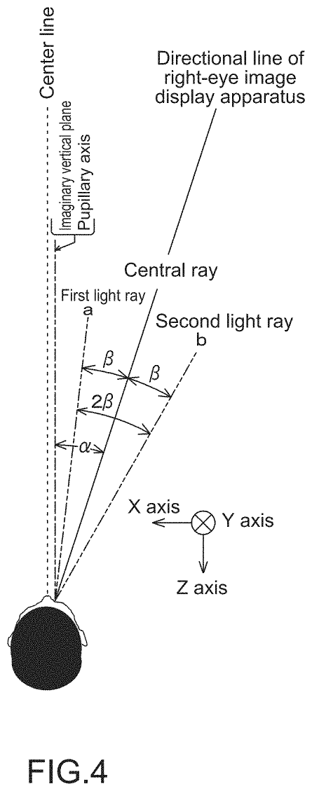

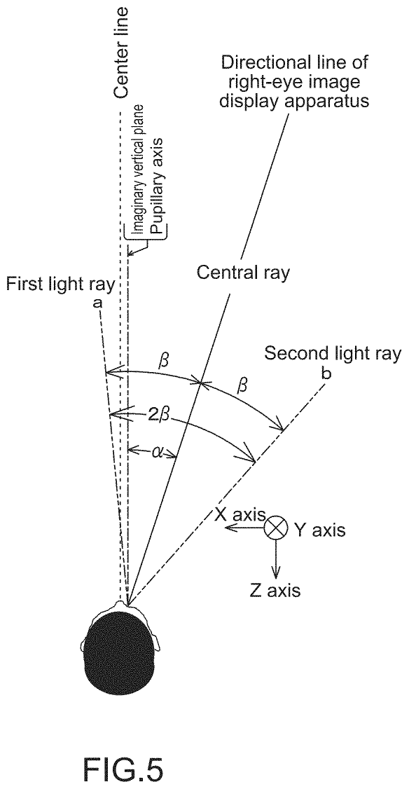

On the other hand, in the display apparatus according to the third aspect of the present disclosure, an image (a virtual image) formed by a left-eye image display apparatus and an image (a virtual image) formed by a right-eye image display apparatus do not overlap since the display apparatus according to the third aspect of the present disclosure is a monocular display apparatus. Thus, a satisfactory display can be performed by conditions indicated below being satisfied, where the conditions can prevent the brain from being confused upon viewing an image (a virtual image) due to the movement of an eye situated on the side on which display is not performed.
[A] α>β is satisfied when a first light ray enters a pupil of an observer from a position closer to an ear of the observer than a pupillary axis (refer to FIG. 4).
[B] (β−α) 5 degrees is satisfied when the first light ray enters the pupil of the observer from a position closer to a nose of the observer than the pupillary axis (refer to FIG. 5).

Further, in the display apparatuses according to the first to third aspects of the present disclosure including the various favorable configurations described above, it is favorable that conditions indicated below be satisfied when an angle formed by a pupillary axis and a normal line of the light guiding plate is θ₀, the normal line passing through an intersection of the pupillary axis and the light guiding plate.
0 degrees≤θ₀≤30 degrees, and
favorably, 0 degrees≤θ₀≤20 degrees.

Furthermore, in the display apparatuses according to the first to third aspects of the present disclosure including the various favorable configurations described above, when a central ray enters the light guiding plate at an angle of incidence θᵢₙ and exits the light guiding plate at an exit angle θₒᵤₜ, the angle of incidence θᵢₙ and the exit angle θₒᵤₜ may exhibit the same value, and a direction at the angle of incidence θᵢₙ relative to the light guiding plate and a direction at the exit angle θₒᵤₜ relative to the light guiding plate (signs of the values of the angle of incidence θᵢₙ and the exit angle θₒᵤₜ) may be different from each other. In other words, an orthogonal projection image obtained by orthogonally projecting a light ray with the angle of incidence θᵢₙ onto the XZ plane and an orthogonal projection image obtained by orthogonally projecting a light ray with the exit angle θₒᵤₜ onto the XZ plane are symmetric about a plane vertical to a line connecting a point, in the light guiding plate, at which the central ray enters the light guiding plate, and a point, in the light guiding plate, at which the central ray exits the light guiding plate, the vertical plane passing through a point at which the line is divided into two equal lines. Further, in this case, θₒᵤₜ=|θ₀−α| is satisfied.

Further, in the display apparatuses according to the first and second aspects of the present disclosure including the various favorable configurations described above, the configuration may be made such that, from among light rays exiting the image forming apparatus, a portion of light rays situated on the side of the ear of the observer is not deflected by the first deflection mechanism. In other words, the configuration may be made such that an image situated on the side of the nose of the observer is not observed by the observer. As a result of adopting such a configuration, the angle of view with respect to horizontal display on the side of the ear of the observer can be made larger. Further, in this case, it is favorable that, from among light rays that exit the image forming apparatus, light rays that are not deflected by the first deflection mechanism account for between 10% and 30% of the entirety of the exiting light rays.

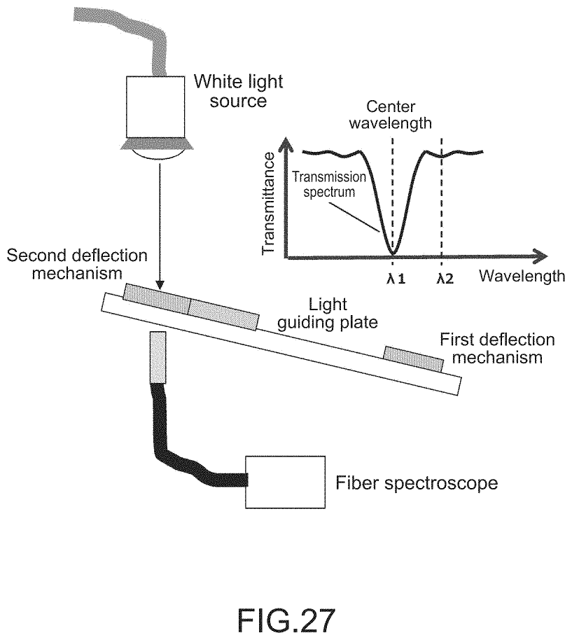

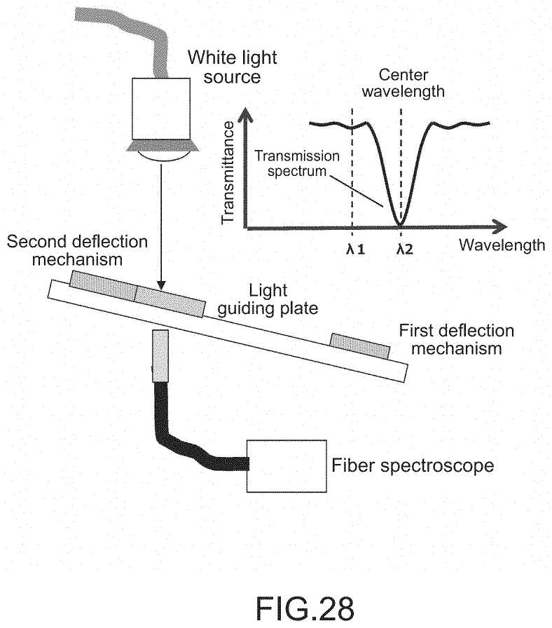

Further, in the display apparatuses according to the first to third aspects of the present disclosure including the various favorable configurations described above,
The slant angle in the first deflection mechanism may differ between a region, in the first deflection mechanism, that is situated on the side of the ear of the observer and a region, in the first deflection mechanism, that is situated on the side of the nose of the observer, and
the slant angle in the second deflection mechanism may differ between a region, in the second deflection mechanism, that is situated on the side of the nose of the observer and a region, in the second deflection mechanism, that is situated on the side of the ear of the observer. As a result of adopting such a configuration, the angle of view with respect to horizontal display on the side of the ear of the observer can be made larger. Note that a state in which there is a difference in slant angle can be confirmed with the following state. When a white light source and a spectroscope are arranged at a certain angle, and when a region on the ear side of the light guiding plate and a region on the nose side of the light guiding plate are arranged between the white light source and the spectroscope at the same angle, as illustrated in FIGS. 27 and 28, there is a difference between regions of different slant angles in a wavelength at which the diffraction occurs.

Furthermore, in the display apparatuses according to the first and second aspects of the present disclosure including the various favorable configurations described above, an image that exits the image forming apparatus of the right-eye image display apparatus and an image that exits the image forming apparatus of the left-eye image display apparatus may be different images. As a result of adopting such a configuration, the angle of view of the display apparatus with respect to horizontal display can be apparently further made larger, such as being made about quasi-twice larger than the angle of view of the image display apparatus with respect to horizontal display.

Further, in the display apparatuses according to the first and second aspects of the present disclosure including the various favorable configurations described above, an image that exits the image forming apparatus of the right-eye image display apparatus may be observed on the side of a right ear of the observer, and an image that exits the image forming apparatus of the left-eye image display apparatus may be observed on the side of a left ear of the observer.

Furthermore, in the display apparatuses according to the first and second aspects of the present disclosure including the various favorable configurations described above, the configuration may be made such that an image that exits the image forming apparatus of the right-eye image display apparatus and an image that exits the image forming apparatus of the left-eye image display apparatus are not fused with each other.

In the display apparatuses according to the first to third aspects of the present disclosure including the favorable configurations described above (they may be hereinafter collectively referred to as a “display apparatus or the like of the present disclosure”), an optical apparatus may specifically include
the light guiding plate off which light that enters from the image forming apparatus is internally totally reflected to propagate through the light guiding plate, the light exiting the light guiding plate to be headed for the observer after the propagation,
the first deflection mechanism deflecting the light entering the light guiding plate such that the light entering the light guiding plate is internally totally reflected off the light guiding plate, and
the second deflection mechanism deflecting the light internally totally reflected off the light guiding plate to propagate through the light guiding plate, such that the light internally totally reflected off the light guiding plate to propagate through the light guiding plate exits the light guiding plate. Note that the term “total reflection” refers to an internal total reflection or a total reflection within the light guiding plate. The light entering from the image forming apparatus is internally totally reflected off the light guiding plate to propagate through the light guiding plate, and then the light exits the light guiding plate to be headed for the observer. The second deflection mechanism includes a virtual image forming region of the optical apparatus.

The image display apparatus in the above-described various configurations of the display apparatus according to the first aspect of the present disclosure may be applied to the image display apparatus of the present disclosure as appropriate.

In the display apparatus or the like of the present disclosure including the favorable configurations described above, the optical apparatus may further include a light adjusting apparatus that adjusts an amount of external light that enters from the outside. The light adjusting apparatus will be described in detail in a fifth embodiment.

In the display apparatus or the like of the present disclosure including the various favorable configurations described above, the optical apparatus is a semi-transmissive (see-through) optical apparatus. Specifically, at least a portion of the optical apparatus that faces an eyeball (pupil) of the observer is made semi-transmissive (see-through), and this makes it possible to see outside through this portion of the optical apparatus. Note that the term “semi-transmissive” may be used herein. The term does not mean that ½ (50%) of incident light is transmitted or reflected, but means that a portion of the incident light is transmitted and the other portion is reflected.

Here, the light entering the light guiding plate may be reflected off the first deflection mechanism, and the light being internally totally reflected off the light guiding plate to propagate through the light guiding plate may be transmitted through and reflected off the second deflection mechanism multiple times. Further, in this case, the first deflection mechanism may serve as a reflecting mirror, and the second deflection mechanism may serve as a semi-transmissive mirror.

In such a configuration, the first deflection mechanism may include a light reflective film (a type of mirror) that is made of, for example, metal including an alloy and off which light that enters the light guiding plate is reflected, a diffraction grating (such as a hologram diffraction grating film) that diffracts light that enters the light guiding plate, a multilayer stacking structure that includes multilayered dielectric film stacks, a half mirror, or a polarization beam splitter. Further, the second deflection mechanism may include a multilayer stacking structure that includes multilayered dielectric film stacks, a half mirror, a polarization beam splitter, or a hologram diffraction grating film. Furthermore, the first deflection mechanism and the second deflection mechanism are arranged in the light guiding plate (incorporated into the light guiding plate). In the first deflection mechanism, parallel light that enters the light guiding plate is reflected off or diffracted by the light guiding plate such that the parallel light entering the light guiding plate is internally totally reflected off the light guiding plate. On the other hand, in the second deflection mechanism, the parallel light that is internally totally reflected off the light guiding plate to propagate through the light guiding plate is reflected off or diffracted by the light guiding plate multiple times, and exits the light guiding plate in the form of the parallel light. In some cases, one of the first deflection mechanism and the second deflection mechanism may be arranged on an outer surface of the light guiding plate.

Further, the first deflection mechanism may diffract the light entering the light guiding plate, and the second deflection mechanism may diffract multiple times the light being internally totally reflected off the light guiding plate to propagate through the light guiding plate. Further, in this case, the first deflection mechanism and the second deflection mechanism may each include a diffraction grating element. Furthermore, the diffraction grating element may include a reflective diffraction grating element or a transmissive diffraction grating element, or one of the diffraction grating elements may include a reflective diffraction grating element and another of the diffraction grating elements may include a transmissive diffraction grating element. Examples of the diffraction grating element include a volume-hologram diffraction grating. The first deflection mechanism including a volume-hologram diffraction grating may be referred to as a “first diffraction grating member” for convenience, and the second deflection mechanism including a volume-hologram diffraction grating may be referred to as a “second diffraction grating member” for convenience. In general, an interference pattern of a hologram diffraction grating layer extends parallel to the Y axis.

An image display apparatus that is included in the display apparatus or the like of the present disclosure, or the image display apparatus of the present disclosure (they may be hereinafter collectively referred to as an “image display apparatus or the like of the present disclosure”) can display an image in one color (for example, blue). However, when a color image is displayed, the first diffraction grating member or the second diffraction grating member may include stacked P diffraction grating layers each including a volume-hologram diffraction grating, in order to meet a diffractive reflection of P types of pieces of light of different P types of wavelength bands (or wavelengths), where, for example, P=3, and the P types are three types of red, green, and blue. An interference pattern corresponding to one type of wavelength band (or wavelength) is formed in a corresponding one of the diffraction grating layers. Further, in order to meet a diffractive reflection of P types of pieces of light of different P types of wavelength bands (or wavelengths), P types of interference patterns may be formed in the first diffraction grating member or second diffraction grating member including a single diffraction grating layer. Furthermore, the angle of view may be equally divided into, for example, three, and the first diffraction grating member or the second diffraction grating member may include stacked diffraction grating layers corresponding to the respective angles of view. Further, for example, a first light guiding plate may include the first diffraction grating member and the second diffraction grating member each including a diffraction grating layer that includes a volume-hologram diffraction grating off which light of a red wavelength band (or wavelength) is diffractively reflected, a second light guiding plate may include the first diffraction grating member and the second diffraction grating member each including a diffraction grating layer that includes a volume-hologram diffraction grating off which light of a green wavelength band (or wavelength) is diffractively reflected, a third light guiding plate may include the first diffraction grating member and the second diffraction grating member each including a diffraction grating layer that includes a volume-hologram diffraction grating off which light of a blue wavelength band (or wavelength) is diffractively reflected, and a structure may be adopted that includes the first light guiding plate, the second light guiding plate, and the third light guiding plate being stacked with spacing between them. Furthermore, the adoption of such a configuration makes it possible to increase the efficiency in diffraction when light of each wavelength band (or wavelength) is diffractively reflected off the first diffraction grating member or the second diffraction grating member, to increase an acceptable angle of the diffraction, and to optimize an angle of the diffraction. It is favorable that a protective member be arranged such that a volume-hologram diffraction grating is not brought into direct contact with atmosphere.

Examples of a material of the first diffraction grating member and the second diffraction grating member include a photopolymer material. It is sufficient if the material and basic structures of the first diffraction grating member and second diffraction grating member each including a volume-hologram diffraction grating are similar to a material and a structure of a conventional volume-hologram diffraction grating. The volume-hologram diffraction grating refers to a hologram diffraction grating off which only +1st-order diffracted light is diffractively reflected. An interference pattern is formed from the interior of the diffraction grating member to the surface of the diffraction grating member, and it is sufficient if a method for forming such an interference pattern itself is similar to a conventional formation method. Specifically, it is sufficient if, for example, object light is irradiated onto a member (such as a photopolymer material) included in a diffraction grating member from a first specified direction on one side of the member, reference light is irradiated onto the member included in the diffraction grating member from a second specified direction on the other side of the member at the same time as the irradiation of the object light, and an interference pattern formed by the object light and the reference light is recorded in the member included in the diffraction grating member. The appropriate selection of the first specified direction, the second specified direction, and wavelengths of the object light and the reference light makes it possible to obtain a desired pitch of an interference pattern on the surface of the diffraction grating member and a desired angle of inclination (a slant angle) of an interference pattern. The angle of inclination of an interference pattern refers to an angle formed by the surface of a diffraction grating member (or a diffraction grating layer) and the interference pattern. When the first diffraction grating member and the second diffraction grating member each have a stacking structure in which P diffraction grating layers each including a volume-hologram diffraction grating are stacked, it is sufficient if such a stack of diffraction grating layers is obtained by individually producing the P diffraction grating layers and stacking (bonding) the individually produced P diffraction grating layers using, for example, an ultraviolet curable adhesive. Further, the P diffraction grating layers may be produced by producing one diffraction grating layer using a viscous photopolymer material, and bonding viscous photopolymer materials one by one on the produced one diffraction grating layer to produce diffraction grating layers. The produced diffraction grating layers are irradiated with energy rays as necessary so that monomers, in a photopolymer material, that are not polymerized when the produced diffraction grating layers are irradiated with object light and reference light, are polymerized to be fixed. Further, heat treatment is performed for stabilization as necessary.

Further, in the image display apparatus or the like of the present disclosure, the optical apparatus may include a semi-transmissive mirror in which light exiting the image forming apparatus enters the semi-transmissive mirror and exits the semi-transmissive mirror to be headed for the pupil of the observer. The light exiting the image forming apparatus may propagate through the air, and may enter the semi-transmissive mirror, or the light may propagate through a transparent member (specifically, a member made of a material similar to a material of the light guiding plate described later) such as a glass plate or a plastic plate, and may enter the semi-transmissive mirror. The semi-transmissive mirror may be attached to the image forming apparatus through the transparent member, or the semi-transmissive mirror may be attached to the image forming apparatus through a member other than the transparent member.

In the image display apparatus or the like of the present disclosure including the various favorable configurations described above, the image forming apparatus may include a plurality of pixels arranged in a two-dimensional matrix. Note that, for convenience, the image forming apparatus having such a configuration is referred to as an “image forming apparatus having a first configuration”.

Examples of the image forming apparatus having the first configuration include an image forming apparatus that includes a reflective spatial light modulating apparatus and a light source, an image forming apparatus that includes a transmissive spatial light modulating apparatus and a light source, and an image forming apparatus that includes a light-emitting element such as an organic electroluminescence (EL), an inorganic EL, a light-emitting diode (LED), and a semiconductor laser element. In particular, it is favorable that the image forming apparatus having the first configuration be the image forming apparatus including a reflective spatial light modulating apparatus and a light source, or the image forming apparatus including a light-emitting element. Examples of the spatial light modulating apparatus include a light bulb such as a transmissive or reflective liquid crystal display apparatus of, for example, liquid crystal on silicon (LCOS); and a digital micromirror device (DMD). Examples of the light source include a light-emitting element. Further, the reflective spatial light modulating apparatus may include a liquid crystal display apparatus and a polarization beam splitter in which a portion of light from the light source is reflected off the polarization beam splitter to be guided to the liquid crystal display apparatus, and a portion of light reflected off the liquid crystal display apparatus passes through the polarization beam splitter to be guided to an optical system. A red-light-emitting element, a green-light-emitting element, a blue-light-emitting element, and a white-light-emitting element may be used as the light-emitting elements included in the light source. Further, red light, green light, and blue light that are respectively emitted by the red-light-emitting element, the green-light-emitting element, and the blue-light-emitting element may be mixed and the brightness may be made uniform using a light pipe to obtain white light. Examples of the light-emitting element include a semiconductor laser element, a solid-state laser, and an LED. It is sufficient if the number of pixels is determined on the basis of the specifications necessary for the image display apparatus. Examples of a specific value of the number of pixels include 320×240, 432×240, 640×480, 854×480, 1024×768, and 1920×1080.

Further, in the image display apparatus or the like of the present disclosure including the favorable configurations described above, the image forming apparatus may include a light source, and a scanning mechanism that scans parallel light emitted by the light source. Note that, for convenience, the image forming apparatus having such a configuration is referred to as an “image forming apparatus having a second configuration”.

Examples of the light source included in the image forming apparatus having the second configuration include a light-emitting element. Specifically, a red-light-emitting element, a green-light-emitting element, a blue-light-emitting element, and a white-light-emitting element may be used as the light-emitting elements. Further, red light, green light, and blue light that are respectively emitted by the red-light-emitting element, the green-light-emitting element, and the blue-light-emitting element may be mixed and the brightness may be made uniform using a light pipe to obtain white light. Examples of the light-emitting element include a semiconductor laser element, a solid-state laser, and an LED. It is sufficient if the number of pixels (virtual pixels) in the image forming apparatus having the second configuration is also determined on the basis of the specifications necessary for the image display apparatus. Examples of a specific value of the number of pixels (virtual pixels) include 320×240, 432×240, 640×480, 854×480, 1024×768, and 1920×1080. Further, when a color image is displayed and the light source includes a red-light-emitting element, a green-light-emitting element, and a blue-light-emitting element, it is favorable that colors be combined using, for example, an X-prism. A microelectromechanical systems (MEMS) mirror or a galvanometer mirror that horizontally scans and vertically scans light emitted by the light source may be used as the scanning mechanism, the MEMS mirror including, for example, a two-dimensionally rotatable micromirror.

In the image forming apparatus having the first configuration or the image forming apparatus having the second configuration, light is formed into a plurality of pieces of parallel light by an optical system (an optical system that forms exiting light into parallel light, may be referred to as a “parallel-light output optical system”, and is, for example, a collimating optical system or a relay optical system in particular), and the plurality of pieces of parallel light enters the light guiding plate. Such a formation of light into pieces of parallel light is necessary since it is necessary that information regarding a light wavefront when the pieces of parallel light enter the light guiding plate be continuously stored after the pieces of parallel light exit the light guiding plate through the first deflection mechanism and the second deflection mechanism. Specifically, for example, it is sufficient if, for example, a light exiting portion of the image forming apparatus is placed at a point (a position) corresponding to a focal length of the parallel-light output optical system, in order to generate a plurality of pieces of parallel light. The parallel-light output optical system includes a function of converting positional information regarding a position of a pixel into angular information regarding an angle with respect to an optical system of the optical apparatus. Examples of the parallel-light output optical system include an optical system that has a positive optical power as a whole and in which a convex lens, a concave lens, a freeform prism, or a hologram lens is used alone, or a combination thereof is used. A light blocking portion that includes an opening may be arranged between the parallel-light output optical system and the light guiding plate, in order to prevent undesired light from exiting the parallel-light output optical system and from entering the light guiding plate.

In the display apparatus or the like of the present disclosure including the various favorable configurations described above, the light guiding plate may include two parallel surfaces (a first surface and a second surface) that each extend parallel to an axis of the light guiding plate (in the longitudinal direction or the horizontal direction), and the light guiding plate may include a transparent substrate. When a surface of the light guiding plate from which light enters the light guiding plate is an entrance surface of the light guiding plate, and a surface of the light guiding plate from which light exits the light guiding plate is an exit surface of the light guiding plate, the first surface may be the entrance surface of the light guiding plate and the exit surface of the light guiding plate, or the first surface may be the entrance surface of the light guiding plate and the second surface may be the exit surface of the light guiding plate. Examples of a material of the light guiding plate include glass including optical glass such as quartz glass and BK7, soda-lime glass, and a plate of white glass; and a plastic material (such as PMMA, a polycarbonate resin, a stacking structure of a polycarbonate resin and an acrylic resin, a cycloolefin polymer, an acrylic resin, an amorphous polypropylene resin, and a styrene resin including a styrene acrylonitrile resin). The light guiding plate is not limited to being flat, and may have a curved shape.

In the display apparatus or the like of the present disclosure, a frame may include a front portion that is arranged in front of the observer, and two temple portions that are respectively rotatably attached to two ends of the front portion through respective hinges, or the front portion and the two temple portions may be integrated. A temple-tip covering portion (a celluloid tip portion) is attached to a tip of each temple portion as necessary. A nose pad portion may be attached to the front portion. The image display apparatus is attached to the frame. Specifically, for example, it is sufficient if a housing that accommodates therein the image forming apparatus is attached to a temple-portion side of the front portion, or to the temple portion, or the housing is attached to a portion including the front portion on the temple-portion side and the temple portion. It is sufficient if the attachment of the image forming apparatus (or the attachment of the housing) is performed by an appropriate method such as a method using a screw. The frame generally has substantially the same structure and appearance as ordinary glasses or sunglasses when the entirety of the display apparatus or the like of the present disclosure is viewed. In other words, except that there is no rim, an assembly of the frame and the nose pad portion has a structure substantially the same as ordinary glasses or sunglasses when the entirety of the display apparatus or the like of the present disclosure is viewed. The nose pad portion may also have a well-known configuration and structure. A speaker or headphones may be attached to the temple portion. A material of the frame including the nose pad portion may be the same as the material of ordinary glasses or sunglasses, such as metal, an alloy, plastics, and a combination thereof.

Further, in the display apparatus or the like of the present disclosure, for reasons of design or for ease of attachment, it is favorable that wiring (such as a signal line and a power supply line) from one image forming apparatus or two image forming apparatuses pass through the temple portion and the temple-tip covering portion to extend outward from a tip of the temple-tip covering portion, and be connected to a control apparatus (a control circuit or a control mechanism). Further, each image forming apparatus may include a headphone portion, and headphone-portion wiring from the image forming apparatus may pass through the temple portion and the temple-tip covering portion to extend toward the headphone portion from the tip of the temple-tip covering portion. Examples of the headphone portion include an in-ear headphone portion and a canal headphone portion. More specifically, it is favorable that the headphone-portion wiring pass behind the auricle (pinna) to extend toward the headphone portion from the tip of the temple-tip covering portion. Further, an image-capturing apparatus may be attached to a center portion of the front portion. Specifically, the image-capturing apparatus includes, for example, a solid-state imaging device that includes a CCD sensor or a CMOS sensor, and a lens. For example, it is sufficient if wiring from the image-capturing apparatus is connected to one image display apparatus (or one image forming apparatus) through the front portion. Further, it is sufficient if the wiring from the image-capturing apparatus is included in the wiring extending from the image display apparatus (or the image forming apparatus).

In the display apparatus or the like of the present disclosure, a signal used to display an image on the image forming apparatus (a signal used to form a virtual image in the optical apparatus) may be received from the outside. In such a configuration, information and data regarding an image to be displayed on the image forming apparatus are recorded, held, or saved in, for example, a so-called cloud computer or server. When the display apparatus includes a communication mechanism such as a cellular phone or a smartphone, or when the display apparatus and the communication mechanism are used in combination, various information and data can be communicated and exchanged between the cloud computer or server and the display apparatus, and a signal based on various information and data, that is, the signal used to display an image on the image forming apparatus (the signal used to form a virtual image in the optical apparatus) can be received. Further, the signal used to display an image on the image forming apparatus (the signal used to form a virtual image in the optical apparatus) may be stored in the display apparatus. The image displayed on the image forming apparatus includes various information and various data. Furthermore, the display apparatus may include an image-capturing apparatus. An image captured by the image-capturing apparatus may be transmitted to a cloud computer or a server through the communication mechanism, various information and data that correspond to the image captured by the image-capturing apparatus may be searched for in the cloud computer or the server, various information and data that are obtained by the search may be transmitted to the display apparatus through the communication mechanism, and an image may be displayed on the image display apparatus on the basis of the various information and data being obtained by the search.

For example, the display apparatus or the like of the present disclosure including the various modifications described above can be used to receive and display an e-mail; to display, for example, various information in various sites on the Internet; to display a moving image and a still image; to display subtitles for, for example, a movie; to display an explanatory text and closed captions regarding a video in synchronization with the video; and to display various descriptions regarding an observation target (various descriptions used at the time of, for example, driving, an operation, a maintenance, and disassembling) in a play, Kabuki, Noh, Kyogen, opera, a concert, a ballet, various theaters, an amusement park, a museum, a tourist spot, a resort, tourist information services, and the like, as well as, for example, an explanatory text that is used to describe, for example, details, the progress, and the background thereof. Further, the display apparatus or the like of the present disclosure including the various modifications described above also serves as a text display apparatus, and can be used to display various descriptions, a symbol, a sign, a mark, an emblem, a design, and the like that are used at the time of, for example, driving, an operation, a maintenance, and disassembling of an observation target such as various apparatuses; and to display various descriptions, a symbol, a sign, a mark, an emblem, a design, and the like regarding an observation target such as a person and a product. With respect to the play, the Kabuki, the Noh, the Kyogen, the opera, the concert, the ballet, the various theaters, the amusement park, the museum, the tourist spot, the resort, the tourist information services, and the like, it is sufficient if a text related to an observation target is displayed in the form of an image on the display apparatus at an appropriate timing. Specifically, for example, according to the progress of, for example, a movie, or according to the progress of, for example, a play, an image signal is transmitted to the display apparatus or a specified identification code is transmitted to a control apparatus, by an operation performed by an operator, or under the control of, for example, a computer, on the basis of a specified schedule and the allotment of time, and an image is displayed on the display apparatus. Further, when various descriptions regarding an observation target such as various apparatuses, a person, and a product are displayed, an image-capturing apparatus is provided to the display apparatus, an image of the observation target such as various apparatuses, a person, and a product is captured by the image-capturing apparatus, and details of the captured image are analyzed by the display apparatus. This makes it possible to display, on the display apparatus, pre-created various descriptions regarding the observation target such as various apparatuses, a person, and a product.

As described above, the image signal destined for the image forming apparatus may include not only an image signal (such as text data) but also, for example, brightness data (brightness information) regarding an image to be displayed, or chromaticity data (chromaticity information) regarding an image to be displayed, or the brightness data and the chromaticity data. The brightness data may be brightness data that corresponds to the brightness of a specified region that includes an observation target viewed through the optical apparatus, and the chromaticity data may be chromaticity data that corresponds to the chromaticity of the specified region including the observation target viewed through the optical apparatus. Accordingly, the brightness (lightness) of an image to be displayed can be controlled by brightness data regarding an image being included, the chromaticity (color) of an image to be displayed can be controlled by chromaticity data regarding an image being included, and the brightness (lightness) and the chromaticity (color) of an image to be displayed can be controlled by brightness data and chromaticity data regarding an image being included. When the brightness data is brightness data that corresponds to the brightness of a specified region that includes an observation target viewed through the image display apparatus, it is sufficient if a value of the brightness data is set such that the brightness of an image exhibits a larger value (that is, an image is displayed more brightly) if the brightness of the specified region including the observation target viewed through the image display apparatus exhibits a larger value. Further, when the chromaticity data is chromaticity data that corresponds to the chromaticity of a specified region that includes an observation target viewed through the image display apparatus, it is sufficient if a value of the chromaticity data is set such that the chromaticity of the specified region including the observation target viewed through the image display apparatus and the chromaticity of an image to be displayed are approximately complementary colors. The complementary colors refer to paired colors lying opposite each other in a color circle. The complementary color is also a complementary color such as green for red, purple for yellow, and orange for blue. The complementary colors also refer to colors that cause a decrease in saturation when one of the colors is mixed with another of the colors in an appropriate ratio, such as white for light or black for an object. However, the complementarity with respect to a visual effect when colors are arranged side by side and the complementarity when colors are mixed are different. The complementary color is also referred to as a complement, a contrasting color, or an opposing color. Note that the complementary colors directly indicate colors that lie opposite each other, whereas the opposing colors may indicate a slightly wider range of colors. Paired complementary colors provide a synergy effect in which one of the colors brings out another of the colors. This is referred to as a harmony of complementary colors.

For example, the display apparatus or the like of the present disclosure may be used for, for example, a head-mounted display (HMD). This makes it possible to make the display apparatus lighter and smaller, to greatly reduce an uncomfortable feeling when a user wears the display apparatus, and further to reduce manufacturing costs. Further, the image display apparatus or the like of the present disclosure can be applied to a head-up display (HUD) that is included in, for example, a vehicle or an aircraft cockpit. Specifically, the HUD can be an HUD in which a virtual image forming region is arranged on a windshield of, for example, a vehicle or an aircraft cockpit, where a virtual image is formed in the virtual image forming region on the basis of light that exits the image forming apparatus. Further, the HUD can be an HUD in which a combiner that includes a virtual image forming region is arranged on a windshield of, for example, a vehicle or an aircraft cockpit, where a virtual image is formed in the virtual image forming region on the basis of light that exits the image forming apparatus.

### First Embodiment

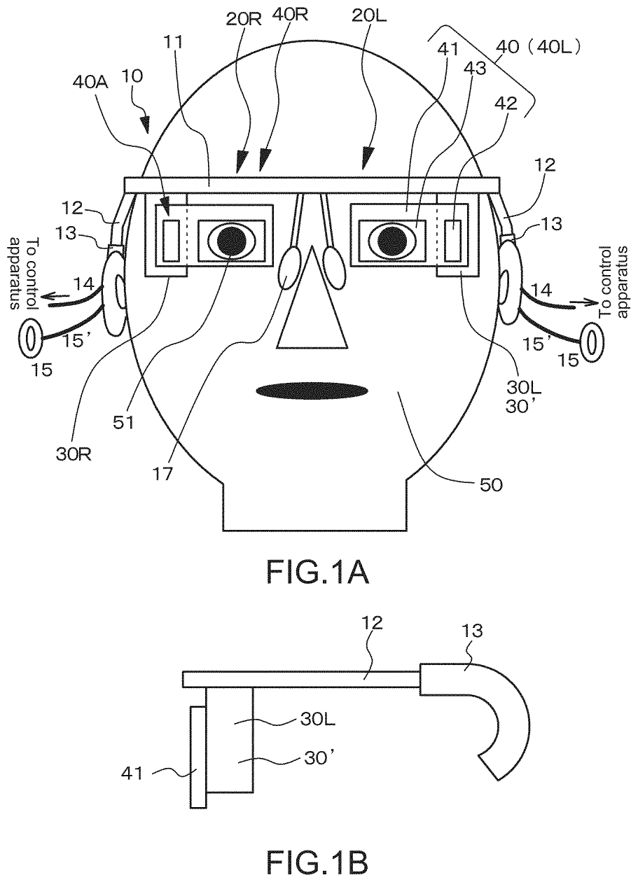

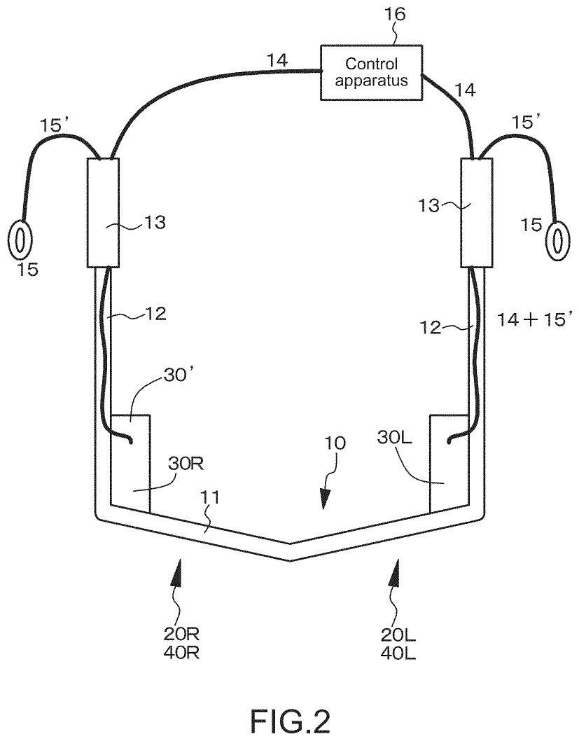

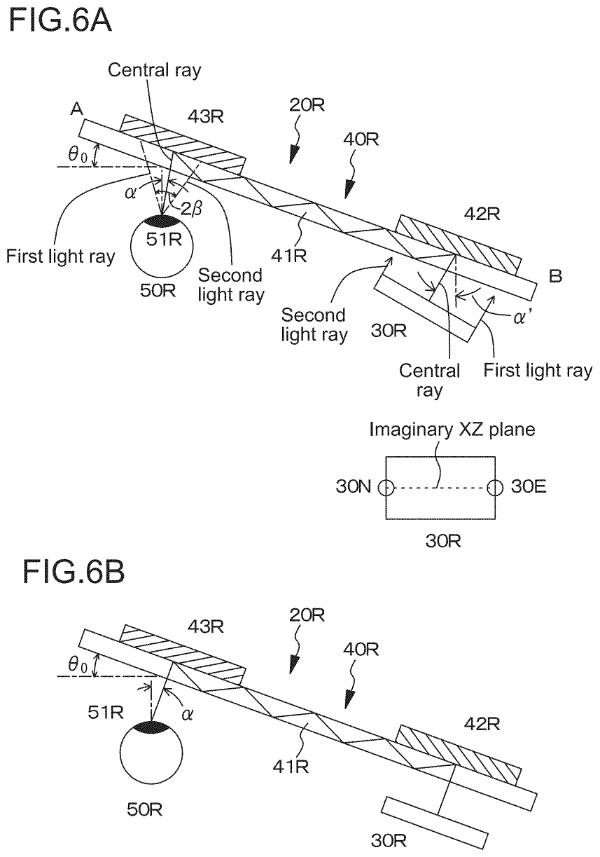

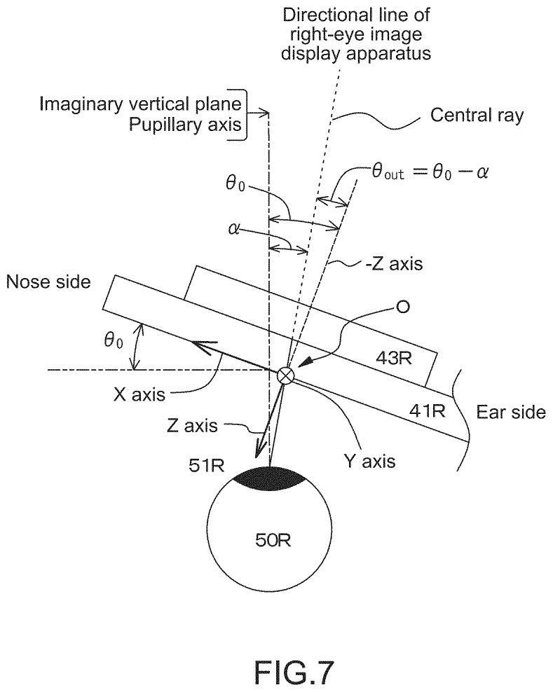

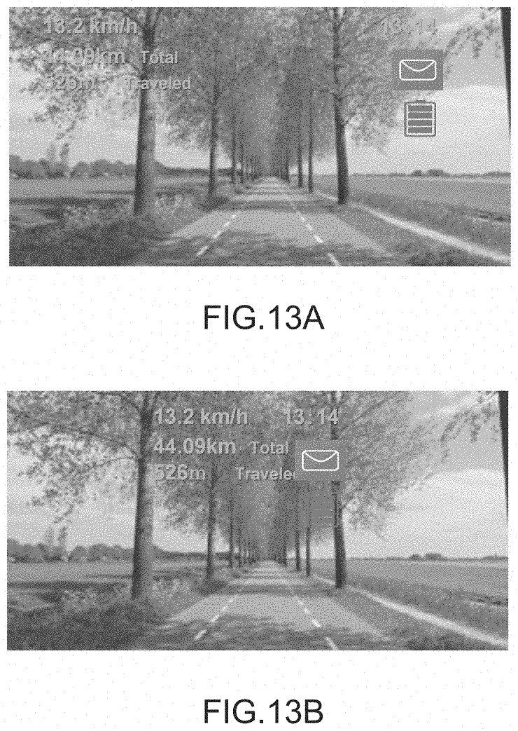

A first embodiment relates to the display apparatuses according to the first to third aspects of the present disclosure. FIG. 1A schematically illustrates the display apparatus of the first embodiment, as viewed from the front, FIG. 1B schematically illustrates the display apparatus of the first embodiment, as viewed from the lateral side (illustrations of a nose pad portion and the like are omitted), and FIG. 2 schematically illustrates the display apparatus of the first embodiment, as viewed from above. Further, FIGS. 3 to 5 are schematic diagrams illustrating an observer, as viewed from above, that are used to describe a positional relationship between an optical apparatus that is included in the display apparatus of the first embodiment and a pupil of the observer, and FIGS. 6A, 6B, 10A, 10B, 11A, 11B, 12A, and 12B are schematic cross-sectional views of the optical apparatus and the like, as viewed from above, that are used to describe the positional relationship between the optical apparatus included in the display apparatus of the first embodiment and the pupil of the observer. Furthermore, FIGS. 7 to 9 are cross-sectional views of an enlarged portion of the schematic cross-sectional view of FIG. 6A illustrating the optical apparatus and the like, as viewed from above. Moreover, FIG. 13A schematically illustrates a state of viewing the outside world and a displayed image using the display apparatus of the first embodiment, and FIG. 13B schematically illustrates a state of viewing the outside world and the displayed image using a conventional display apparatus. Note that hatching is omitted in FIGS. 6A, 6B, 7 to 9, 10A, 10B, 11A, 11B, 12A, and 12B.

The display apparatus of the first embodiment is a display apparatus that is used for a head-mounted display (HMD), and is a binocular display apparatus, the display apparatus of the first embodiment including
a frame 10, and
a right-eye image display apparatus 20R and a left-eye image display apparatus 20L that are attached to the frame 10,
the image display apparatuses 20R and 20L respectively including
image forming apparatuses 30R and 30L, and
optical apparatuses 40R and 40L that respectively guide images coming from the respective image forming apparatuses 30R and 30L to a pupil 51 of an observer 50.

The optical apparatuses 40R and 40L each include
a light guiding plate 41,
a first deflection mechanism 42 that is attached to the light guiding plate 41, and
a second deflection mechanism 43 that is attached to the light guiding plate 41, in which
an image from the image forming apparatus 30R, 30L enters the first deflection mechanism 42, is deflected by the first deflection mechanism 42, is guided through the light guiding plate 41, enters the second deflection mechanism 43, is deflected by the second deflection mechanism 43, and enters the pupil 51 of the observer 50.

Here, the case in which a central ray that exits from a center point of an image forming region in the image forming apparatus 30R 30L, is deflected by the second deflection mechanism 43 to enter the pupil 51 of the observer 50, as illustrated in FIGS. 3, 6A, and 7 to 9, is discussed. The central ray corresponds to a directional line of the image display apparatus and is indicated by a solid line in FIGS. 3 and 7 to 9, and an extension of the central ray is indicated by a dotted line in FIGS. 7 to 9. When a point, on the light guiding plate 41, at which the central ray exits the light guiding plate 41 is an origin O, and when, in an XYZ orthogonal coordinate system of which axes of X, Y, and Z pass through the origin O, an axis of the light guiding plate 41 (in a longitudinal direction of the light guiding plate 41, or the horizontal direction) that passes through the origin O is an X axis, an axis that passes through the origin O and extends in parallel with a normal line of the light guiding plate 41 (in a thickness direction of the light guiding plate) is a Z axis, and an axis (in a width direction of the light guiding plate, the height direction, or the vertical direction) that is orthogonal to the X and Z axes is a Y axis,
the central ray enters from a position closer to the image forming apparatus 30R, 30L (from a position closer to a right ear of the observer in the case of the right-eye image forming apparatus 30R, and from a position closer to a left ear of the observer in the case of the left-eye image forming apparatus 30L) than an imaginary vertical plane that includes a pupillary axis (indicated by a dot-dash line in FIGS. 3, 7, and 9) and is parallel to the Y axis. Here, the right-eye image display apparatus 20R is described on the basis of coordinate axes of a right-handed system, and the same applies to the left-eye image display apparatus 20L on the basis of coordinate axes of a left-handed system. Further, in FIG. 6A, a first light ray enters the pupil 51 of the observer 50 from a position closer to a nose of the observer 50 than the pupillary axis, due to the layout of the figure. However, the first light ray actually enters the pupil 51 of the observer 50 from a position closer to an ear of the observer 50 than the pupillary axis.

Further, an image formed by the right-eye image display apparatus 20R and an image formed by the left-eye image display apparatus 20L are not fused with each other.

Furthermore, the image display apparatuses 20R and 20L of the first embodiment respectively include
the image forming apparatuses 30R and 30L, and
the optical apparatuses 40R and 40L that respectively guide images coming from the respective image forming apparatuses 30R and 30L to the pupil 51 of the observer 50,
the optical apparatuses 40R and 40L each including
the light guiding plate 41,
the first deflection mechanism 42 attached to the light guiding plate 41, and
the second deflection mechanism 43 attached to the light guiding plate 41, in which
an image from the image forming apparatus 30R, 30L enters the first deflection mechanism 42, is deflected by the first deflection mechanism 42, is guided through the light guiding plate 41, enters the second deflection mechanism 43, is deflected by the second deflection mechanism 43, and enters the pupil 51 of the observer 50, and
when a central ray that exits from a center point of an image forming region in the image forming apparatus 30R 30L, is deflected by the second deflection mechanism 43 to enter the pupil 51 of the observer 50, and when a point, on the light guiding plate 41, at which the central ray exits the light guiding plate 41 is an origin O, and when, in an XYZ orthogonal coordinate system of which axes of X, Y, and Z pass through the origin O, an axis of the light guiding plate 41 that passes through the origin O is an X axis, an axis that passes through the origin O and extends in parallel with a normal line of the light guiding plate 41 is a Z axis, and an axis that is orthogonal to the X and Z axes is a Y axis,
the central ray enters from a position closer to the image forming apparatus 30R, 30L (from a position closer to the right ear of the observer in the case of the right-eye image forming apparatus 30R, and from a position closer to the left ear of the observer in the case of the left-eye image forming apparatus 30L) than an imaginary vertical plane that includes the pupillary axis and is parallel to the Y axis.

Further, the display apparatus of the first embodiment is a monocular display apparatus, the display apparatus of the first embodiment including
the frame 10, and
an image display apparatus 20 that is attached to the frame 10,
the image display apparatus 20 including
an image forming apparatus 30, and
an optical apparatus 40 that guides an image coming from the image forming apparatus 30 to the pupil 51 of the observer 50,
the optical apparatus 40 including
the light guiding plate 41,
the first deflection mechanism 42 attached to the light guiding plate 41, and
the second deflection mechanism 43 attached to the light guiding plate 41, in which
an image from the image forming apparatus 30 enters the first deflection mechanism 42, is deflected by the first deflection mechanism 42, is guided through the light guiding plate 41, enters the second deflection mechanism 43, is deflected by the second deflection mechanism 43, and enters the pupil 51 of the observer 50, and
when a central ray that exits from a center point of an image forming region in the image forming apparatus 30, is deflected by the second deflection mechanism 43 to enter the pupil 51 of the observer 50, and when a point, on the light guiding plate 41, at which the central ray exits the light guiding plate 41 is an origin O, and when, in an XYZ orthogonal coordinate system of which axes of X, Y, and Z pass through the origin O, an axis of the light guiding plate 41 that passes through the origin O is an X axis, an axis that passes through the origin O and extends in parallel with a normal line of the light guiding plate 41 is a Z axis, and an axis that is orthogonal to the X and Z axes is a Y axis,
the central ray enters from a position closer to the image forming apparatus 30 (from a position closer to the ear of the observer) than an imaginary vertical plane that includes the pupillary axis and is parallel to the Y axis. Furthermore, α>β (β will be described later) is satisfied when the first light ray enters the pupil of the observer from a position closer to the ear of the observer than the pupillary axis, as illustrated in FIG. 4. (β−α) 5 degrees is satisfied when the first light ray enters the pupil of the observer from a position closer to the nose of the observer than the pupillary axis, as illustrated in FIG. 5.

Note that, in the following descriptions, the image forming apparatuses 30R, 30L, and 30 may be collectively simply referred to as the “image forming apparatus 30”, and the optical apparatuses 40R, 40L, and 40 may be collectively simply referred to as the “optical apparatus 40”.

The optical apparatus 40 is a semi-transmissive (see-through) optical apparatus. Specifically, at least a portion of the optical apparatus 40 that faces an eyeball (the pupil) 51 of the observer 50 is made semi-transmissive (see-through), and this makes it possible to see outside through this portion of the optical apparatus 40 (and also through a light adjusting apparatus described later if the light adjusting apparatus is arranged). The image forming apparatus 30 displays an image (a virtual image) in one color (for example, blue), but the configuration is not limited thereto. The image forming apparatus 30 can also display a color image.

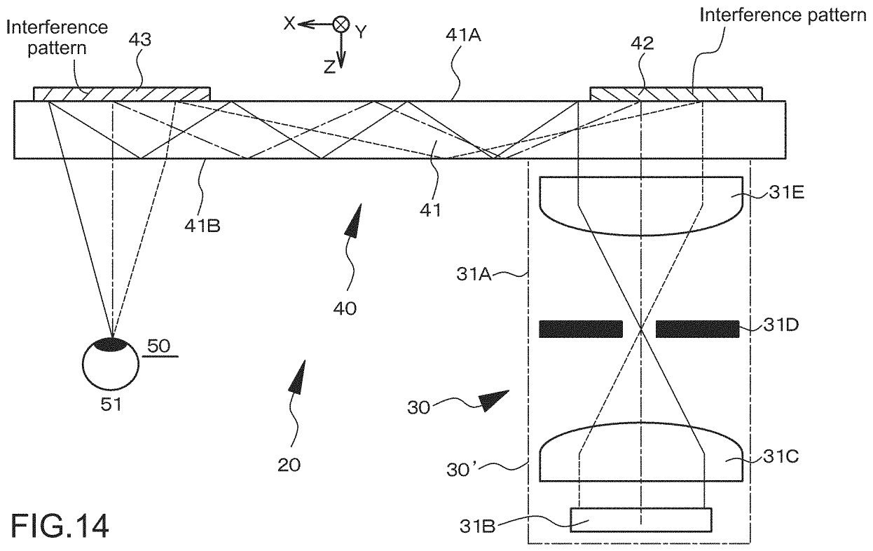

Here, the description is made in reference to FIG. 14 schematically illustrating the arrangement of the image forming apparatus and the optical apparatus. In the display apparatus of the first embodiment, the optical apparatus 40 includes
the light guiding plate 41 off which light that enters from the image forming apparatus 30 is internally totally reflected to propagate through the light guiding plate 41, the light exiting the light guiding plate 41 to be headed for the observer 50 after the propagation,
the first deflection mechanism 42 deflecting the light entering the light guiding plate 41 such that the light entering the light guiding plate 41 is internally totally reflected off the light guiding plate 41, and
the second deflection mechanism 43 deflecting the light internally totally reflected off the light guiding plate 41 to propagate through the light guiding plate 41, such that the light internally totally reflected off the light guiding plate 41 to propagate through the light guiding plate 41 exits the light guiding plate 41. In other words, light that enters from the image forming apparatus 30 is internally totally reflected off the light guiding plate 41 to propagate through the light guiding plate 41, and then exits the light guiding plate 41 to be headed for the observer 50. The entirety of the light guiding plate 41 is arranged closer to the center of a face of the observer 50 than the image forming apparatus 30. A light ray that enters a region, in the first deflection mechanism 42, that is situated on the side of the ear of the observer (refer to “B” in FIG. 6A) exits a region, in the second deflection mechanism 43, that is situated on the side of the nose of the observer (refer to “A” in FIG. 6A), and a light ray that enters a region, in the first deflection mechanism 42, that is situated on the side of the nose of the observer exits a region, in the second deflection mechanism 43, that is situated on the side of the ear of the observer. A central ray enters the center of the pupil 51 of the observer.

As illustrated in FIG. 14, the light guiding plate 41 made of optical glass or a plastic material includes two parallel surfaces (a first surface 41A and a second surface 41B) that each extend in parallel with a direction (an X direction) in which light propagates through the light guiding plate 41 due to the light being internally totally reflected off the light guiding plate 41. The first surface 41A and the second surface 41B face each other. Further, parallel light enters the light guiding plate 41 from the second surface 41B corresponding to a light entrance surface, is internally totally reflected off the light guiding plate 41 to propagate through the light guiding plate 41, and then exits the light guiding plate 41 from the second surface 41B corresponding to a light exit surface. However, the configuration is not limited thereto, and the first surface 41A may be the light entrance surface, and the second surface 41B may be the light exit surface.

Further, in the display apparatus of the first embodiment, the image forming apparatus 30 is attached to a temple-portion side of a front portion 11. Specifically, a housing 30′ that accommodates therein the image forming apparatus 30 is attached to the front portion 11. Note that the housing 30′ may be attached to the temple portion 12, or may be attached to a portion including the front portion 11 and the temple portion 12. Further, the housing 30′ may be arranged closer to the nose of the observer 50 than the temple portion 12 (refer to FIG. 1A), or may be arranged farther away from the nose of the observer 50 than the temple portion 12. It is sufficient if the attachment of the image forming apparatus 30 (or the attachment of the housing 30′) is performed by an appropriate method such as a method using a screw.

The frame 10 includes the front portion 11 arranged in front of the observer 50, the temple portions 12 respectively extending from two ends of the front portion 11, and nose pad portions 17. An end 40A of the optical apparatus 40 (specifically, the light guiding plate 41) is attached to the image forming apparatus 30 arranged on the temple-portion side of the front portion 11. Specifically, the end 40A of the optical apparatus 40 is attached to the image forming apparatus 30 using, for example, an adhesive.

In the display apparatus of the first embodiment, the two temple portions 12 is each integrated with the front portion 11. Note that the temple portion 12 may be rotatably attached to the end of the front portion 11 through a hinge. In other words, the frame 10 includes the front portion 11 arranged in front of the observer 50, the two temple portions 12 respectively extending from the two ends of the front portion 11, and temple-tip covering portions (also referred to as celluloid tip portions, ear-fit portions, or ear pads) 13 that are respectively attached to tips of the respective temple portions 12. The frame 10 generally has substantially the same appearance as ordinary glasses or sunglasses when the entirety of the display apparatus of the first embodiment is viewed. A material of the nose pad portion 17 and the frame 10 may be the same as the material of ordinary glasses or sunglasses, such as metal, an alloy, plastics, and a combination thereof.

Further, wiring (such as a signal line and a power supply line) that extends from the image forming apparatus 30 passes through the temple portion 12 and the temple-tip covering portion 13 to extend outward from a tip of the temple-tip covering portion 13, and is connected to a control apparatus (a control circuit or a control mechanism) 16. Furthermore, the image forming apparatus 30 includes a headphone portion 15, and headphone-portion wiring 15′ that extends from the image forming apparatus 30 passes through the temple portion 12 and the temple-tip covering portion 13 to extend toward the headphone portion 15 from the tip of the temple-tip covering portion 13. More specifically, the headphone-portion wiring 15′ passes behind the auricle (pinna) to extend toward the headphone portion 15 from the tip of the temple-tip covering portion 13. According to such a configuration, the display apparatus has a simple design without giving the impression that the headphone portion 15 and the headphone-portion wiring 15′ are randomly arranged.

As described above, the wiring (such as a signal line and a power supply line) 14 is connected to the control apparatus (control circuit) 16. The control apparatus 16 includes, for example, an image information storing apparatus (not illustrated). Then, processing for displaying an image is performed by the control apparatus 16. The control apparatus 16 and the image information storing apparatus may include a well-known circuit.

In the display apparatus of the first embodiment, the first deflection mechanism (first diffraction grating member) 42 and the second deflection mechanism (second diffraction grating member) 43 each include a hologram diffraction grating layer. Further, light that enters the light guiding plate 41 is diffractively reflected off the first deflection mechanism 42, and the light being internally totally reflected off the light guiding plate 41 to propagate through the light guiding plate 41 is diffractively reflected off the second deflection mechanism 43. The hologram diffraction grating layer includes, for example, a reflective hologram diffraction grating layer that is specifically a reflective volume-hologram diffraction grating layer. The light guiding plate 41 includes a transparent substrate made of glass or a resin. The second surface 41B of the light guiding plate 41 is an entrance surface, and the first deflection mechanism (first diffraction grating member) 42 and the second deflection mechanism (second diffraction grating member) 43 are arranged on the first surface 41A being included in the light guiding plate 41 and facing the second surface 41B.

Further, as described above, in the display apparatus of the first embodiment, a central ray enters from a position closer to the image forming apparatus (from a position closer to the ear of the observer) than an imaginary vertical plane that includes the pupillary axis and is parallel to the Y axis. Here, α>0 degrees, favorably a 5 degrees, and more favorably α≥10 degrees is satisfied when α is an angle formed by the pupillary axis and an orthogonal projection image obtained by orthogonally projecting a central ray onto an XZ plane. Further, α>β is satisfied when 2β is an angle formed by a first-light-ray orthogonal projection image and a second-light-ray orthogonal projection image, the first-light-ray orthogonal projection image being obtained by orthogonally projecting a first light ray (indicated by a dot-dot-dash line a in FIG. 3) onto the XZ plane, the first light ray exiting an ear-side end 30E (refer to FIG. 6A) of the image forming apparatus 30 that is situated in an imaginary XZ plane in the image forming apparatus 30, and entering the pupil 51 of the observer 50, the imaginary XZ plane corresponding to the XZ plane, the second-light-ray orthogonal projection image being obtained by orthogonally projecting a second light ray (indicated by a dot-dot-dash line b in FIG. 3) onto the XZ plane, the second light ray exiting a nose-side end 30N (refer to FIG. 6A) of the image forming apparatus 30 that is situated in the imaginary XZ plane, and entering the pupil 51 of the observer 50. Furthermore, it is favorable that conditions indicated below be satisfied when an angle formed by the pupillary axis and a normal line of the light guiding plate 41 is θ₀, the normal line passing through an intersection of the pupillary axis and the light guiding plate 41.
0 degrees≤θ₀≤30 degrees, and
favorably, 0 degrees≤θ₀≤20 degrees.

Further, in the display apparatus of the first embodiment, a value of an angle of incidence θᵢₙ and an absolute value of an exit angle θₒᵤₜ are the same value when a central ray enters the light guiding plate 41 at the angle of incidence θᵢₙ and exits the light guiding plate 41 at the exit angle θₒᵤₜ. In other words, an orthogonal projection image obtained by orthogonally projecting a light ray with the angle of incidence θᵢₙ onto the XZ plane and an orthogonal projection image obtained by orthogonally projecting a light ray with the exit angle θₒᵤₜ onto the XZ plane are symmetric about a plane vertical to a line connecting a point, in the light guiding plate 41, at which the central ray enters the light guiding plate 41, and a point, in the light guiding plate 41, at which the central ray exits the light guiding plate 41, the vertical plane passing through a point at which the line is divided into two equal lines. Further, in this case, θₒᵤₜ=|θ₀−α| is satisfied. Furthermore, an angle α′ formed by the central ray entering the light guiding plate 41 and a line that is parallel to the pupillary axis and passes through the point, in the light guiding plate 41, at which the central ray enters the light guiding plate 41, is |2θ₀−α|.

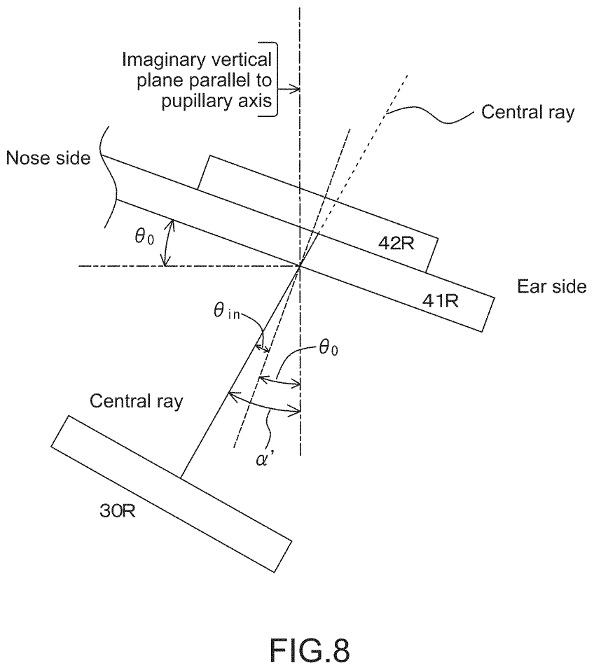

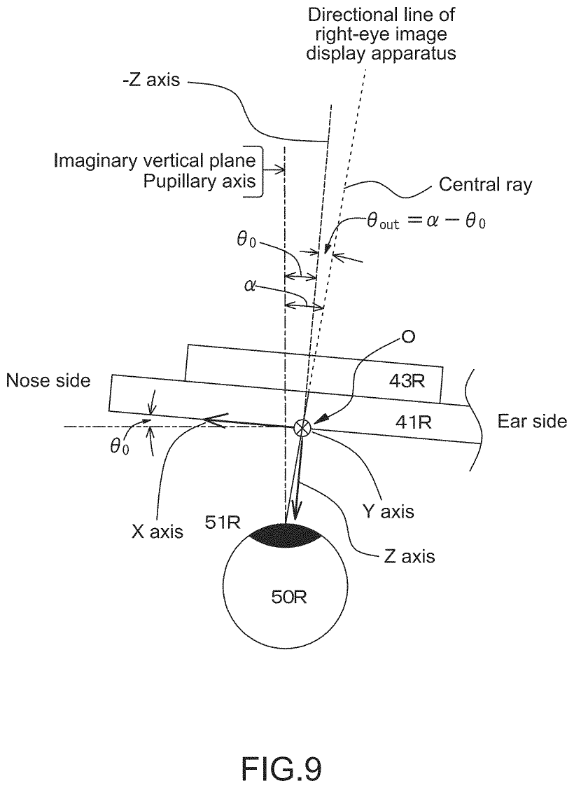

Here, FIG. 7 is an enlarged portion of the schematic cross-sectional view of FIG. 6A illustrating a portion of the optical apparatus and the like, as viewed from above, the portion of the optical apparatus including a second deflection mechanism 43R. FIG. 8 is an enlarged portion of the schematic cross-sectional view of FIG. 6A illustrating a portion of the optical apparatus and the like, as viewed from above, the portion of the optical apparatus including a first deflection mechanism 42R. FIG. 9 is an enlarged portion of the schematic cross-sectional view of FIG. 6A illustrating a modification of the portion of the optical apparatus and the like, as viewed from above, the portion of the optical apparatus including the second deflection mechanism 43R. Note that, in FIGS. 7 and 9, a normal line of the light guiding plate 41 (a normal line of the light guiding plate 41 that passes through the origin O) that defines a value of the exit angle θₒᵤₜ when the central ray exits the light guiding plate 41 at the exit angle θₒᵤₜ is indicated by a dashed line. In the example of FIG. 7,
θ₀≥α, where

θₒᵤₜ=θ₀−α.
On the other hand, in the example of FIG. 9,
θ₀<α, where

θₒᵤₜ=α−θ₀.

The positional relationship between the optical apparatus included in the display apparatus of the first embodiment and the pupil of the observer is described using the right-eye image display apparatus with reference to FIGS. 6A, 6B, 10A, 10B, 11A, 11B, 12A, and 12B, which are schematic cross-sectional views of the optical apparatus and the like, as viewed from above. In the figures, the letter “R” is placed at the end of a reference numeral of a structural element of the right-eye image display apparatus since the figures are related to the right-eye image display apparatus.

In the examples of FIGS. 6A, 10A, 11A, and 12A,
θ₀=20 degrees,
α=10 degrees,
2β=18 degrees,
θᵢₙ=10 degrees, and
θₒᵤₜ=10 degrees(=|θ₀−α|).
On the other hand, in the examples of FIGS. 6B, 10B, 11B, and 12B,
θ₀=20 degrees,
α=20 degrees,
2β=18 degrees,
θᵢₙ=0 degrees, and
θₒᵤₜ=0 degrees(=|θ₀−α|).

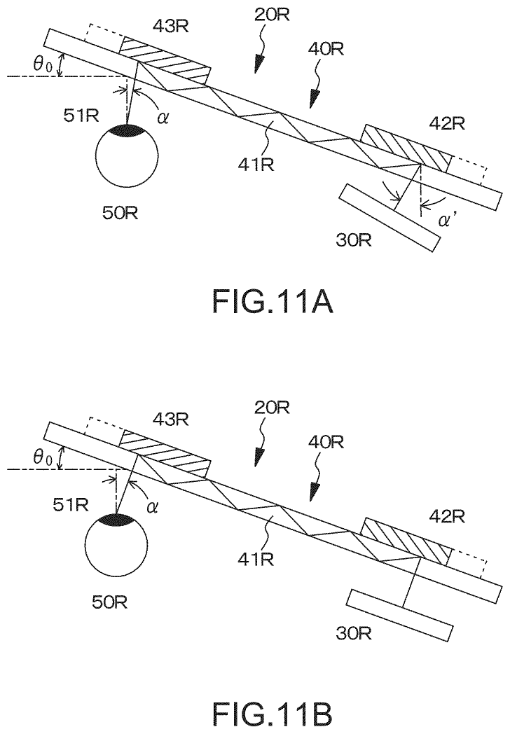

In the examples of FIGS. 6A, 6B, 11A, and 11B, the slant angle in the first deflection mechanism 42 is set to a constant value, and the slant angle in the second deflection mechanism 43 is set to a constant value.

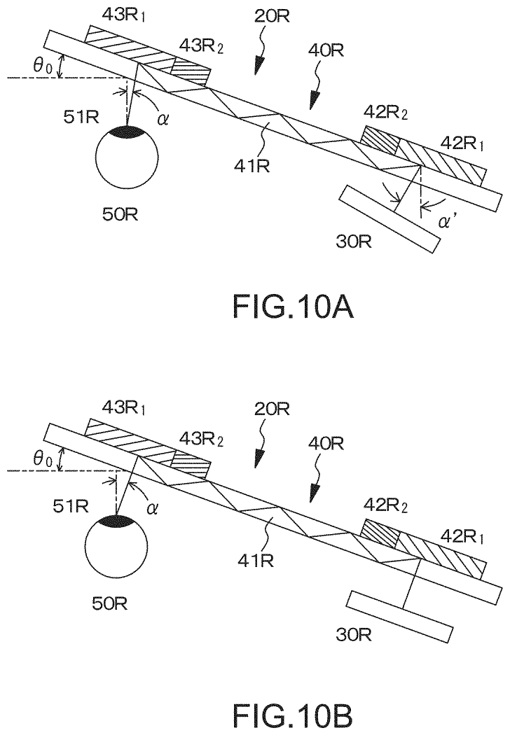

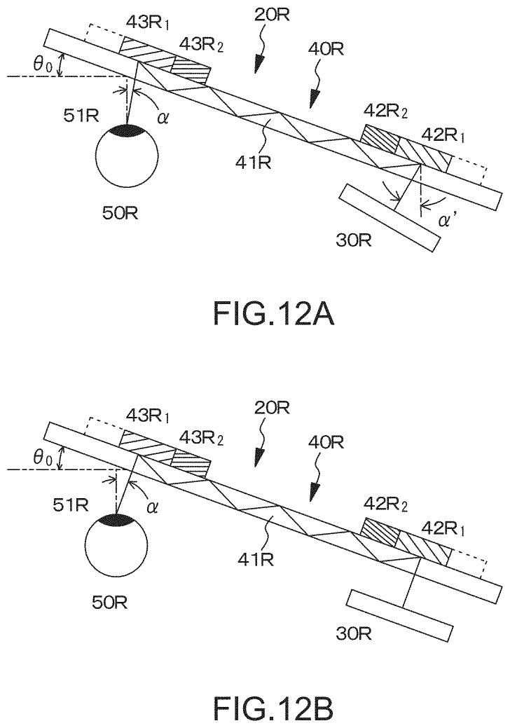

In the examples of FIGS. 10A, 10B, 12A, and 12B,
the slant angle in the first deflection mechanism 42 differs between a region 421, in the first deflection mechanism 42, that is situated on the side of the ear of the observer 50 and a region 42₂, in the first deflection mechanism 42, that is situated on the side of the nose of the observer 50, and
the slant angle in the second deflection mechanism 43 differs between a region 43₁, in the second deflection mechanism 43, that is situated on the side of the nose of the observer 50 and a region 432, in the second deflection mechanism 43, that is situated on the side of the ear of the observer 50. As a result of adopting such a configuration, the angle of view with respect to horizontal display on the side of the ear of the observer 50 can be made larger.

In the examples of FIGS. 11A, 11B, 12A, and 12B, from among light rays exiting the image forming apparatus 30, a portion of light rays situated on the side of the ear of the observer 50 is not deflected by the first deflection mechanism 42. In other words, an image situated on the side of the nose of the observer 50 is not observed by the observer 50. In this case, it is favorable that, from among light rays that exit the image forming apparatus 30, light rays that are not deflected by the first deflection mechanism 42 account for between 10% and 30% of the entirety of the exiting light rays. A region for light rays, from among light rays that exit the image forming apparatus 30, that are not deflected by the first deflection mechanism 42, is indicated by a dotted line in the figures. The adoption of such a configuration makes it possible to more certainly achieve a state in which an image that exits the image forming apparatus of the right-eye image display apparatus and an image that exits the image forming apparatus of the left-eye image display apparatus are not fused with each other.

FIG. 13A schematically illustrates a state of viewing the outside world and a displayed image using the display apparatus of the first embodiment, and FIG. 13B schematically illustrates a state of viewing the outside world and the displayed image using a conventional display apparatus. In the display apparatus of the first embodiment, an image that exits the image forming apparatus 30R of the right-eye image display apparatus 20R and an image that exits the image forming apparatus 30L of the left-eye image display apparatus 20L are different images. Further, the image exiting the image forming apparatus 30R of the right-eye image display apparatus 20R is observed on the side of the right ear of the observer 50, and the image exiting the image forming apparatus 30L of the left-eye image display apparatus 20L is observed on the side of the left ear of the observer 50. The image exiting the image forming apparatus 30R of the right-eye image display apparatus 20R and the image exiting the image forming apparatus 30L of the left-eye image display apparatus 20L are not fused with each other.

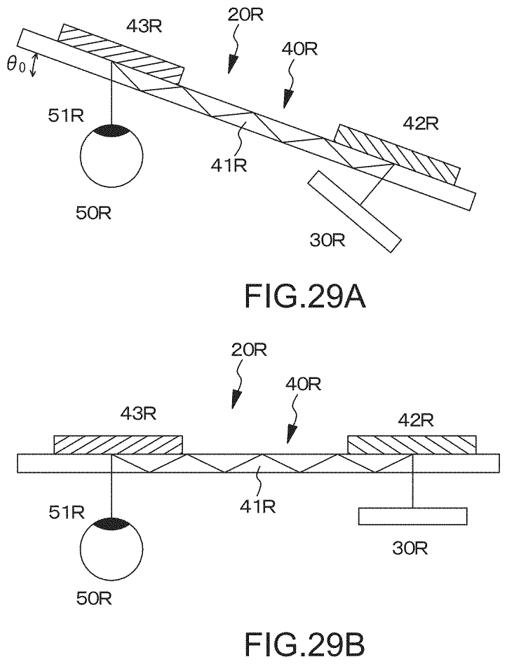

A positional relationship between the optical apparatus included in the conventional display apparatus and the pupil of the observer is illustrated in FIGS. 29A and 29B, which are schematic cross-sectional views of the optical apparatus and the like, as viewed from above. In such a conventional display apparatus, α=0 degrees, and specifically,
θ₀=20 degrees,
α=0 degrees,
2β=18 degrees,
θᵢₙ=0 degrees, and
θₒᵤₜ=20 degrees(=|θ₀−α|)
(refer to FIG. 29A). Further,
θ₀=0 degrees,
α=0 degrees,
2β=18 degrees,
θᵢₙ=0 degrees, and
θₒᵤₜ=0 degrees(=|θ₀−α|)
(refer to FIG. 29B). As illustrated in FIG. 13B, in the conventional display apparatus, an image that exits the image forming apparatus 30 of the right-eye image display apparatus and an image that exits the image forming apparatus 30 of the left-eye image display apparatus are the same image, and the image exiting the image forming apparatus 30 of the right-eye image display apparatus and the image exiting the image forming apparatus 30 of the left-eye image display apparatus are observed in a center portion of a region observed by the observer 50. Further, an image formed by the right-eye image display apparatus and an image formed by the left-eye image display apparatus are fused with each other.

The image display apparatus 20 will be described in detail in second to fifth embodiments.

As described above, in the display apparatus of the first embodiment, a central ray enters from a position closer to the image forming apparatus (from a position closer to the ear of an observer) than an imaginary vertical plane, or an image formed by the right-eye image display apparatus and an image formed by the left-eye image display apparatus are not fused with each other. Thus, for example, it is difficult for an observer to recognize, with his/her left eye, an image formed by the right-eye image display apparatus, and this makes it possible to prevent the visibility from being decreased due to the brain being confused when the observer tries to recognize the image with his/her left eye. Further, a wider angle of view for an image can be obtained using a lightweight see-through head-mounted display.

### Second Embodiment

In the second to fourth embodiments, the image forming apparatus and the optical apparatus are described. In the second embodiment, the image forming apparatus and the optical apparatus that are included in the display apparatus described in the first embodiment are described. FIG. 14 schematically illustrates the arrangement of the image forming apparatus and the optical apparatus.

In the display apparatus of the second embodiment, specifically, the first deflection mechanism 42 and the second deflection mechanism 43 are arranged on (specifically, bonded to) the surface of the light guiding plate 41 (specifically, the first surface 41A of the light guiding plate 41). Further, light that enters the light guiding plate 41 is diffractively reflected off the first deflection mechanism 42, and the light being internally totally reflected off the light guiding plate 41 to propagate through the light guiding plate 41 is diffractively reflected off the second deflection mechanism 43. As described above, the first deflection mechanism 42 and the second deflection mechanism 43 each include a diffraction grating member, specifically a reflective diffraction grating member, and more specifically a reflective volume-hologram diffraction grating member. The first deflection mechanism including a hologram diffraction grating member is hereinafter referred to as a “first diffraction grating member 42” for convenience, and the second deflection mechanism including a hologram diffraction grating member is hereinafter referred to as a “second diffraction grating member 43” for convenience.

Further, in the second embodiment, or in the third embodiment described later, the first diffraction grating member 42 and the second diffraction grating member 43 each include a single diffraction grating layer. An interference pattern that corresponds to one type of wavelength band (or wavelength) is formed in each diffraction grating layer made of a photopolymer material, and is produced by a conventional method. A pitch of an interference pattern formed in a diffraction grating layer (a diffraction optical element) is constant, and the interference patterns are linear and extend in parallel with a Y direction. The first diffraction grating member 42 and the second diffraction grating member 43 each have an axis extending in parallel with an X direction, and a normal line extending in parallel with a Z direction.

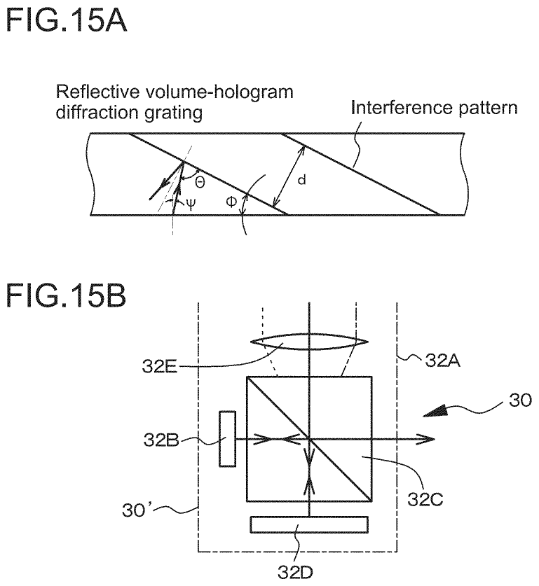

FIG. 15A is a schematic cross-sectional view of an enlarged portion of a reflective volume-hologram diffraction grating member. An interference pattern that has an angle of inclination (a slant angle) φ is formed in the reflective volume-hologram diffraction grating member. The angle of inclination φ refers to an angle formed by an interference pattern and the surface of a reflective volume-hologram diffraction grating member. The interference pattern is formed from the interior of the reflective volume-hologram diffraction grating member to the surface of the reflective volume-hologram diffraction grating member. The interference pattern satisfies the Bragg condition. The Bragg condition refers to a condition that satisfies Formula (A) indicated below. In Formula (A), m is a positive integer, λ is a wavelength, d is a pitch of a grating plane (spacing of an imaginary plane including an interference pattern in a normal direction), and Θ is a complement of an angle at which light enters an interference pattern. Further, when light enters a diffraction grating member at an angle of incidence ψ, a relationship between Θ, the angle of inclination φ, and the angle of incidence ψ is represented by Formula (B) indicated below.

m·λ=2·d·sin(Θ) (A)

Θ·=90°−(φ+ψ) (B)

As described above, the first diffraction grating member 42 is arranged on (bonded to) the first surface 41A of the light guiding plate 41, and parallel light that enters the light guiding plate 41 from the second surface 41B is diffractively reflected off the first diffraction grating member 42 such that the parallel light entering the light guiding plate 41 is internally totally reflected off the light guiding plate 41. Further, as described above, the second diffraction grating member 43 is arranged on (bonded to) the first surface 41A of the light guiding plate 41, and the parallel light that is internally totally reflected off the light guiding plate 41 to propagate through the light guiding plate 41 is diffractively reflected off the second diffraction grating member 43 multiple times, and exits the light guiding plate 41 from the second surface 41B in the form of the parallel light.

As described above, parallel light is internally totally reflected off the light guiding plate 41 to propagate through the light guiding plate 41, and then the parallel light exits the light guiding plate 41. In this case, the number of times that light traveling through the light guiding plate 41 is totally reflected before the light reaches the second diffraction grating member 43 differs depending on the angle of view, since the light guiding plate 41 is thin and a path of the light is long. More specifically, with respect to parallel light that enters the light guiding plate 41, the number of reflections of parallel light that enters the light guiding plate 41 at an angle at which the parallel light enters in a direction of the second diffraction grating member 43, is smaller than the number of reflections of parallel light that enters the light guiding plate 41 at an angle at which the parallel light enters in a direction opposite to the second diffraction grating member 43. The reason is that, when light that propagates through the light guiding plate 41 impinges on an inner face of the light guiding plate 41, the light forms a smaller angle with a normal line of the light guiding plate 41 in the case of parallel light that is diffractively reflected off the first diffraction grating member 42, and enters the light guiding plate 41 at an angle at which the parallel light enters in a direction of the second diffraction grating member 43, compared to the case of parallel light that enters the light guiding plate 41 at an angle at which the parallel light enters in the opposite direction. Further, the shape of an interference pattern formed in the second diffraction grating member 43 and the shape of an interference pattern formed in the first diffraction grating member 42 are symmetric about an imaginary plane that is vertical to the axis of the light guiding plate 41. Surfaces of the first diffraction grating member 42 and the second diffraction grating member 43 that do not face the light guiding plate 41 may be covered with a transparent resin plate or a transparent resin film to prevent the first diffraction grating member 42 and the second diffraction grating member 43 from being damaged. Further, a transparent protective film may be attached to the second surface 41B to protect the light guiding plate 41.

Basically, the light guiding plate 41 in the third embodiment described later includes the same configuration and structure as those of the light guiding plate 41 described above.

In the second embodiment or in the fourth embodiment described later, the image forming apparatus 30 is the image forming apparatus having the first configuration, and includes a plurality of pixels arranged in a two-dimensional matrix. Specifically, the image forming apparatus 30 includes an organic EL display apparatus 31B. An image that exits the organic EL display apparatus 31B passes through a first convex lens 31C that is included in a lens system. The image further passes through a second convex lens 31E that is included in the lens system to become parallel light, and is headed for the light guiding plate 41. A front focal position f_{2F} of the second convex lens 31E coincides with a back focal position f_{1B} of the first convex lens 31C. Further, a diaphragm 31D is arranged at the back focal position f_{1B} of the first convex lens 31C (the front focal position f_{2F} of the second convex lens 31E). The diaphragm 31D corresponds to an image exit section. The entirety of the image forming apparatus 30 is accommodated in a housing 31A (the housing 30′). The housing 31A is attached to the frame 10 by an appropriate method. The organic EL display apparatus 31B includes a plurality of (for example, 640×480) pixels (organic EL elements) arranged in a two-dimensional matrix.

Alternatively, as illustrated in FIG. 15B, the image forming apparatus 30 is the image forming apparatus having the first configuration, and includes a plurality of pixels arranged in a two-dimensional matrix. Specifically, the image forming apparatus 30 includes a reflective spatial light modulating apparatus, and a light source 32B including a light-emitting diode that emits white light. The entirety of the image forming apparatus 30 is accommodated in a housing 32A (indicated by a dot-dash line in FIG. 15B). The housing 32A (the housing 30′) includes an opening (not illustrated), and light exits an optical system (a parallel-light output optical system or a collimating optical system 32E) through the opening. The housing 32A is attached to the frame 10 by an appropriate method. The reflective spatial light modulating apparatus includes a liquid crystal display apparatus (LCD) 32D of LCOS that serves as a light bulb. The reflective spatial light modulating apparatus further includes a polarization beam splitter 32C in which a portion of light from the light source 32B is reflected off the polarization beam splitter 32C to be guided to the liquid crystal display apparatus 32D, and a portion of light reflected off the liquid crystal display apparatus 32D passes through the polarization beam splitter 32C to be guided to the optical system 32E. The liquid crystal display apparatus 32D includes a plurality of (for example, 640×480) pixels (liquid crystal cells or liquid crystal display elements) arranged in a two-dimensional matrix. The polarization beam splitter 32C has a well-known configuration and structure. Unpolarized light emitted by the light source 32B impinges on the polarization beam splitter 32C. A p-polarization component passes through the polarization beam splitter 32C, and exits the system. On the other hand, an s-polarization component is reflected off the polarization beam splitter 32C, and enters the liquid crystal display apparatus 32D. Further, the s-polarization component is internally reflected off the liquid crystal display apparatus 32D, and exits the liquid crystal display apparatus 32D. Here, from among light exiting the liquid crystal display apparatus 32D, light exiting a pixel used to display “white” includes a large amount of p-polarization component, and light exiting a pixel used to display “black” includes a large amount of s-polarization component. Thus, from among light that exits the liquid crystal display apparatus 32D and impinges on the polarization beam splitter 32C, the p-polarization component passes through the polarization beam splitter 32C to be guided to the optical system 32E. On the other hand, the s-polarization component is reflected off the polarization beam splitter 32C to be returned to the light source 32B. The optical system 32E includes, for example, a convex lens, and the image forming apparatus 30 (more specifically, the liquid crystal display apparatus 32D) is arranged at a point (a position) corresponding to a focal length of the optical system 32E, in order to generate parallel light. An image exiting the image forming apparatus 30 reaches the pupil 51 of the observer 50 through the optical element 40.

Information and data regarding an image to be displayed on the image display apparatus 20, or a signal to be received by a reception apparatus is recorded, held, or saved in, for example, a so-called cloud computer or server. When the display apparatus includes a communication mechanism (the transmission-and-reception apparatus) such as a cellular phone or a smartphone, or when the communication mechanism (the reception apparatus) is incorporated into the control apparatus (the control circuit or the control mechanism) 16 included in the display apparatus, various information and data, or a signal can be communicated and exchanged between the cloud computer or server and the display apparatus through the communication mechanism; a signal based on various information and data, that is, a signal used to display an image on the image display apparatus 20 can be received; and the reception apparatus can receive a signal.

Specifically, when an observer performs input to a cellular phone or a smartphone to make a request for “information” to be obtained, the cellular phone or the smartphone accesses a cloud computer or a server to obtain the “information” from the cloud computer or the server. Accordingly, the control apparatus 16 receives a signal used to display an image on the image display apparatus 20. The control apparatus 16 performs well-known image processing on the basis of the received signal, and displays the “information” on the image forming apparatus 30 in the form of an image. The image of the “information” is displayed at a specified position on the light guiding plate 41 in the form of a virtual image, on the basis of light exiting the image forming apparatus 30, the specified position being controlled by the control apparatus 16. In other words, a virtual image is formed in a portion of a virtual image forming region (the second deflection mechanism 43).

In some cases, a signal used to display an image on the image display apparatus 20 may be stored in the display apparatus (specifically, in the control apparatus 16).

Further, an image captured by a camera (not illustrated) that is included in the display apparatus may be transmitted to a cloud computer or a server through the communication mechanism, various information and data that correspond to the image captured by the camera may be searched for in the cloud computer or the server, various information and data that are obtained by the search may be transmitted to the display apparatus through the communication mechanism, and an image may be displayed on the image display apparatus 20 on the basis of the various information and data being obtained by the search. Furthermore, when such a configuration and input of “information” are used in combination, information regarding, for example, the location of an observer and a direction that the observer is facing can be added. This makes it possible to display the “information” on the image forming apparatus 30 with a higher degree of accuracy.

### Third Embodiment

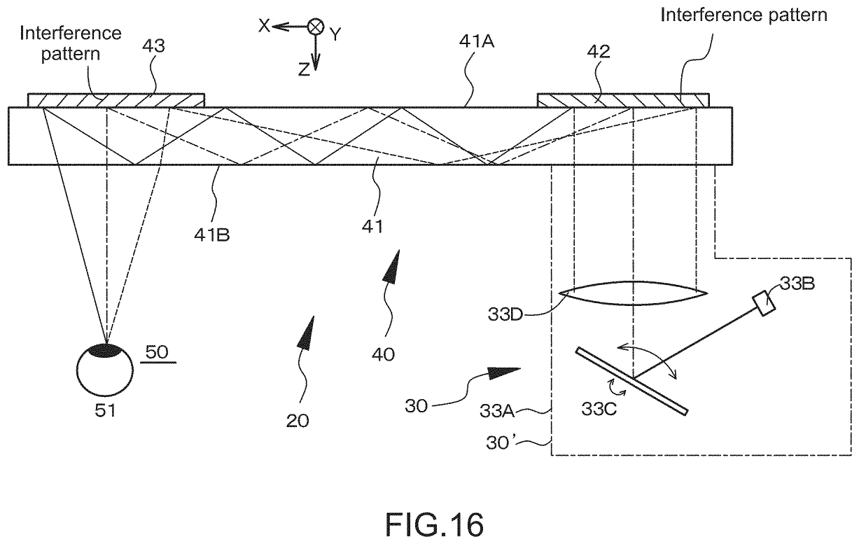

FIG. 16 is a conceptual diagram of the image display apparatus 20 in the display apparatus (a head-mounted display) of the third embodiment. In the third embodiment, the image forming apparatus 30 is the image forming apparatus having the second configuration. In other words, the image forming apparatus 30 includes a light source 33B, a scanning mechanism 33C that two-dimensionally scans parallel light emitted by the light source 33B, and a lens system 33D that forms light emitted by the light source 33B into parallel light. The entirety of the image forming apparatus 30 is accommodated in a housing 33A (the housing 30′). The housing 33A includes an opening (not illustrated), and light exits the lens system 33D through the opening. Further, the housing 33A is attached to the frame 10 by an appropriate method.

The light source 33B includes, for example, a semiconductor laser element. Further, light emitted by the light source 33B is formed into parallel light by a lens (not illustrated). The parallel light is horizontally scanned and vertically scanned by the scanning mechanism 33C, which is a MEMS mirror that includes a two-dimensionally rotatable micromirror, and can two-dimensionally scan incident parallel light. A kind of two-dimensional image is formed, and a virtual pixel (the number of pixels may be, for example, the same as the number of pixels in the second embodiment) is generated. Further, light from the virtual pixel (the scanning mechanism 33C corresponding to an image exit portion) passes through the lens system 33D having a positive optical power. A pencil of light is formed into parallel light, and the parallel light enters the light guiding plate 41.

### Fourth Embodiment

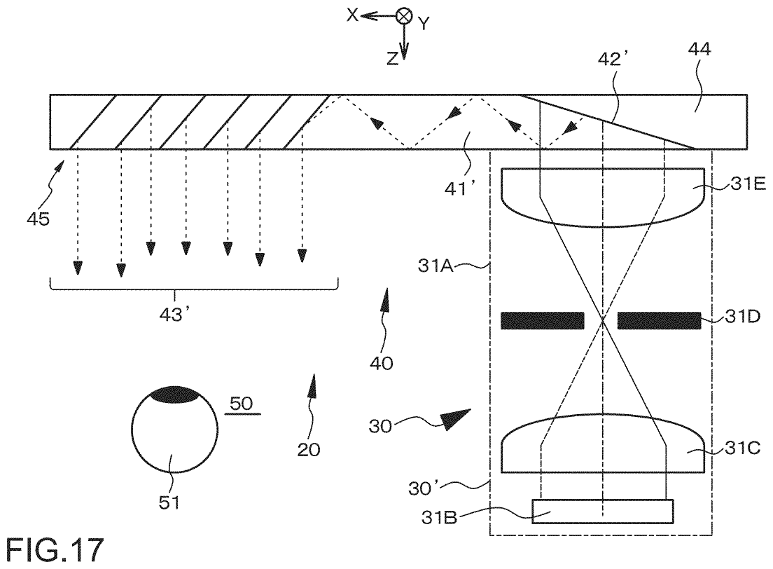

FIG. 17 is a conceptual diagram of the image display apparatus 20 in the display apparatus (a head-mounted display) of the fourth embodiment. In the fourth embodiment, a first deflection mechanism 42′ and a second deflection mechanism 43′ are arranged in a light guiding plate 41′. Further, light that enters the light guiding plate 41′ is reflected off the first deflection mechanism 42′, and the light being internally totally reflected off the light guiding plate 41′ to propagate through the light guiding plate 41′ is transmitted through and reflected off the second deflection mechanism 43′ multiple times. In other words, the first deflection mechanism 42′ serves as a reflecting mirror, and the second deflection mechanism 43′ serves as a semi-transmissive mirror. More specifically, the first deflection mechanism 42′ provided in the light guiding plate 41′ includes a light reflective film (a type of mirror) that is made of aluminum (Al) and off which light that enters the light guiding plate 41′ is reflected. On the other hand, the second deflection mechanism 43′ provided in the light guiding plate 41′ includes a multilayer stacking structure that includes multilayered dielectric film stacks. The dielectric film stack includes, for example, a TiO₂ film that is a high dielectric constant material, and a SiO₂ film that is a low dielectric constant material. Japanese Unexamined Patent Application Publication No. 2005-521099 discloses a multilayer stacking structure that includes multilayered dielectric film stacks. The figure illustrates six-layer dielectric film stacks, but the configuration is not limited thereto. A thin portion made of the same material as the material of the light guiding plate 41′ is situated between the dielectric film stacks. In the first deflection mechanism 42′, parallel light that enters the light guiding plate 41′ is reflected off the light guiding plate 41′ such that the parallel light entering the light guiding plate 41′ is internally totally reflected off the light guiding plate 41′. On the other hand, in the second deflection mechanism 43′, the parallel light that is internally totally reflected off the light guiding plate 41′ to propagate through the light guiding plate 41′ is reflected off the light guiding plate 41′ multiple times, and exits the light guiding plate 41′ to be headed for the pupil 51 of the observer 50 in the form of the parallel light.

With respect to the first deflection mechanism 42′, it is sufficient if a portion 44 to which the first deflection mechanism 42′ is provided, is cut out of the light guiding plate 41′ to form, in the light guiding plate 41′, an inclined surface on which the first deflection mechanism 42′ is to be formed; a light reflective film is formed on the inclined surface using vacuum deposition; and thereafter the portion 44 cut out of the light guiding plate 41′ is bonded to the first deflection mechanism 42′. Further, with respect to the second deflection mechanism 43′, it is sufficient if a multilayer stacking structure in which a material (such as glass) that is the same as the material of the light guiding plate 41′, and a dielectric film stack (that can be formed using, for example, vacuum deposition) are arranged in a multilayered formation, is produced; a portion 45 to which the second deflection mechanism 43′ is provided, is cut out of the light guiding plate 41′ to form an inclined surface in the light guiding plate 41′; the multilayer stacking structure is bonded to the inclined surface; and polishing or the like is performed to arrange the external shape. Accordingly, the optical apparatus 40 in which the first deflection mechanism 42′ and the second deflection mechanism 43′ are provided in the light guiding plate 41′ can be obtained.

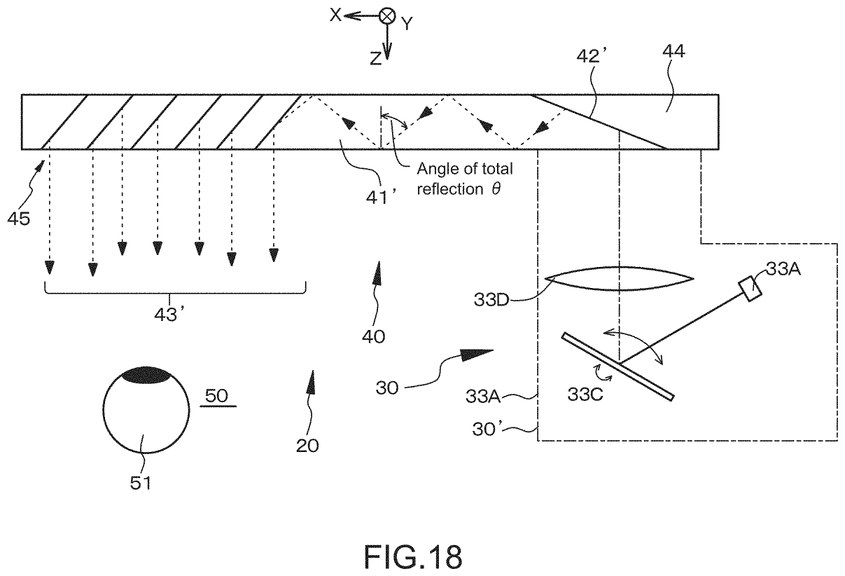

Alternatively, FIG. 18 illustrates a conceptual diagram of the image display apparatus 20 in a modification of the display apparatus (a head-mounted display) of the fourth embodiment. In the example illustrated in FIG. 18, the image forming apparatus 30 is the image forming apparatus having the second configuration, as in the case of the third embodiment.

### Fifth Embodiment

The fifth embodiment is a modification of the first to fourth embodiments, and the optical apparatus 40 further includes a light adjusting apparatus that adjusts an amount of external light that enters from the outside.

Although the details will be described later, the light adjusting apparatus may include
a first substrate,
a second substrate that faces the first substrate,
a first transparent electrode that is provided on a facing surface of the first substrate that faces the second substrate,
a second transparent electrode that is provided on a facing surface of the second substrate that faces the first substrate, and
a light adjusting layer that is situated between the first transparent electrode and the second transparent electrode.

Further, in this case, for example,
the first transparent electrode may include a plurality of strip-shaped first transparent electrode segments each extending in a first direction,
the second transparent electrode may include a plurality of strip-shaped second transparent electrode segments each extending in a second direction that is different from the first direction, and
the light-shielding rate of a portion of the light adjusting apparatus that corresponds to a region in which the first transparent electrode segment and the second transparent electrode segment overlap (a smallest-unit region in which the light-shielding rate of the light adjusting apparatus is changed) may be controlled by voltages applied to the first transparent electrode segment and the second transparent electrode segment being controlled. In other words, the light-shielding rate may be controlled on the basis of passive matrix. For example, the first direction and the second direction may be orthogonal to each other. For example, a voltage higher than a voltage applied to the second transparent electrode is applied to the first transparent electrode during an operation of the light adjusting apparatus.

Further, a thin film transistor (TFT) may be provided to each smallest-unit region in which the light-shielding rate of the light adjusting apparatus is changed, in order to control the light-shielding rate of the smallest-unit region. In other words, the light-shielding rate may be controlled on the basis of active matrix. Furthermore, at least one of the first transparent electrode or the second transparent electrode may be a so-called solid-pattern electrode (unpatterned electrode).

One of the first substrate and the second substrate may also serve as the light guiding plate. Such a configuration results in being able to reduce the weight of the entirety of the display apparatus, and thus in not making a user of the display apparatus (an observer) feel uncomfortable. One of the first substrate and the second substrate may be thinner than another of the first substrate and the second substrate. In the display apparatus including the light adjusting apparatus, it is sufficient if the size and the position of a region in which light is actually adjusted by the light adjusting apparatus, are determined on the basis of a signal used to display an image on the image forming apparatus. The size of the light adjusting apparatus may be the same as, or may be larger than, or may be smaller than the size of the optical apparatus. In short, it is sufficient if the second deflection mechanism (a virtual image forming region) is situated in an orthogonal projection image obtained by orthogonally projecting the light adjusting apparatus.

The light adjusting layer may include an optical shutter using a change in the color of a substance generated due to an oxidation-reduction reaction of an inorganic or organic electrochromic material. Specifically, the light adjusting layer may include an inorganic or organic electrochromic material. Further, the light adjusting layer may have a stacking structure in which inorganic electrochromic material layers such as a WO₃ layer/a Ta₂O₅ layer/an Ir_{X}Sn_{1-X}O layer are stacked, as viewed from the first transparent electrode, or a stacking structure in which inorganic electrochromic material layers such as a WO₃ layer/a Ta₂O₅ layer/an IrOₓ layer are stacked, as viewed from the first transparent electrode. An MoO₃ layer or a V₂O₅ layer may be used instead of the WO₃ layer. Further, a ZrO₂ layer or a zirconium phosphate layer may be used instead of the IrOₓ layer. Furthermore, for example, a Prussian blue complex/a nickel-substituted Prussian blue complex may be used instead of the IrOₓ layer. For example, the electrochromic material disclosed in Japanese Patent Application Laid-open No. 2014-111710 or Japanese Patent Application Laid-open No. 2014-159385 may also be used as the organic electrochromic material. Further, the light adjusting layer may include an electrophoretic dispersion liquid. The light adjusting apparatus may include an optical shutter using electrodeposition based on an electrodeposition/dissociation phenomenon caused due to a reversible oxidation-reduction reaction of metal (such as silver particles), that is, the light adjusting layer may include an electrolyte containing metal ions. When the light adjusting layer includes an electrolyte layer containing metal ions, it is favorable that the metal ion be a silver ion, and the electrolyte contain at least one salt selected from the group consisting of LiX, NaX, and KX, where X is a fluorine atom, a chlorine atom, a bromine atom, or an iodine atom. Further, in some cases, a liquid crystal shutter, or an optical shutter that controls the transmittance on the basis of an electrowetting phenomenon may be used as the light adjusting apparatus. Furthermore, a color given to light by the light adjusting apparatus may be a fixed color such as black, or light that passes through the light adjusting apparatus may be given a desired color by the light adjusting apparatus, and the color given to the light by the light adjusting apparatus may be variable. Specifically, it is sufficient if, for example, a light adjusting apparatus that turns light red, a light adjusting apparatus that turns light green, and a light adjusting apparatus that turns light blue are stacked.

Further, the light adjusting layer may include an electrophoretic dispersion liquid. The light adjusting apparatus may include an optical shutter using electrodeposition based on an electrodeposition/dissociation phenomenon caused due to a reversible oxidation-reduction reaction of metal (such as silver particles), that is, the light adjusting layer may include an electrolyte containing metal ions.

Here, the electrophoretic dispersion liquid contains a large number of charged electrophoretic particles and a dispersion medium of a color different from the color of the electrophoretic particles. For example, the first transparent electrode is patterned and the second transparent electrode is not patterned (a so-called solid-pattern electrode), and the electrophoretic particles are negatively charged. In this case, the negatively charged electrophoretic particles migrate to cover the second transparent electrode when a relatively negative voltage is applied to the first transparent electrode and a relatively positive voltage is applied to the second transparent electrode. Thus, the light-shielding rate of the light adjusting apparatus becomes high. Conversely, the electrophoretic particles migrate to cover the first transparent electrode when a relatively positive voltage is applied to the first transparent electrode and a relatively negative voltage is applied to the second transparent electrode. Thus, the light-shielding rate of the light adjusting apparatus becomes low. The light-shielding rate of the light adjusting apparatus can be controlled by appropriately performing such an application of a voltage to the transparent electrode. The voltage may be a DC voltage or an AC voltage. It is sufficient if the patterned first transparent electrode has a shape that makes it possible to optimize the light-shielding rate of the light adjusting apparatus when the electrophoretic particles migrate to cover the first transparent electrode and the light-shielding rate of the light adjusting apparatus becomes low, and it is sufficient if the shape of the patterned first transparent electrode is determined by various tests being conducted. An insulation layer may be formed on the transparent electrode as necessary. Examples of a material of the insulation layer include a colorless, transparent insulating resin, and specifically include an acrylic resin, an epoxy resin, a fluorine resin, a silicone resin, a polyimide resin, and a polystyrene resin.

Specific examples of a material of the transparent first substrate and the transparent second substrate that are included in the light adjusting apparatus include a substrate of transparent glass such as soda-lime glass and a plate of white glass; a plastic substrate; a plastic sheet; and a plastic film. Here, examples of plastics include polyethylene terephthalate, polyethylene naphthalate, polycarbonate, cellulose esters such as cellulose acetate, fluorine polymers such as a copolymer of polyvinylidene fluoride or polytetrafluoroethylene and hexafluoropropylene, polyether such as polyoxymethylene, polyacetal, polystyrene, polyethylene, polypropylene, polyolefins such as a methylpentene polymer, polyimide such as polyamide-imide or polyetherimide, polyamide, polyethersulfone, polyphenylene sulfide, polyvinylidene fluoride, tetraacetylcellulose, brominated phenoxy, polyarylate, and polysulfone. The plastic sheet and the plastic film may be rigid so that they are not easily bent, or may be flexible. When the first substrate and the second substrate are transparent plastic substrates, a barrier layer made of an inorganic material or an organic material may be formed on an inner face of the substrate.

The first substrate and the second substrate are bonded to each other by being sealed with a sealing member at an outer edge. Various resins such as a thermosetting resin, a photocurable resin, a moisture-curable resin, and an anaerobic curable resin may be used as the sealing member, which is also called a sealing agent. Examples of the various resins include an epoxy resin, a urethane resin, an acrylic resin, an acetate vinyl resin, an ene-thiol resin, a silicone resin, and a modified polymer resin.

As described above, the first transparent electrode may be patterned or unpatterned. The second transparent electrode may also be patterned or unpatterned. Specific examples of a material of the first transparent electrode and the second transparent electrode include indium tin oxide (ITO, including Sn-doped In₂O₃, crystalline ITO, and amorphous ITO), fluorine-doped SnO₂ (FTO), IFO (F-doped In₂O₃), antimony-doped SnO₂ (ATO), SnO₂, ZnO (including Al-doped ZnO and B-doped ZnO), indium zinc oxide (IZO), spinel oxide, oxide having a YbFe₂O₄ structure, and conducting polymers such as polyaniline, polypyrrole, and polythiophene. The material is not limited thereto, and two or more of them may be used in combination. The first transparent electrode and the second transparent electrode may be formed by, for example, physical vapor deposition (PVD) such as vacuum deposition or sputtering, any type of chemical vapor deposition (CVD), or any type of coating. Patterning may be performed by any method such as etching, a liftoff process, or any type of method using a mask.

In some cases, the light adjusting apparatus may be removably arranged. In order to removably arrange the light adjusting apparatus, for example, the light adjusting apparatus may be attached to, for example, the frame using a transparent plastic screw. Further, a groove may be formed in the frame, and the light adjusting apparatus may be fit into the groove to attach the light adjusting apparatus to the frame. Furthermore, a magnet may be attached to the frame to attach the light adjusting apparatus to the frame. A slide portion may be provided to the frame, and the light adjusting apparatus may be fitted into the slide portion. Further, at least one of the first substrate or the second substrate may be attached to, for example, the frame. Furthermore, the light adjusting apparatus may be attached to the optical apparatus. In other words, the light adjusting apparatus may be closely attached to the optical apparatus, or may be attached to the optical apparatus with a space between the light adjusting apparatus and the optical apparatus. Further, in this case, the light guiding plate and one of the substrates included in the light adjusting apparatus may be bonded to each other by being sealed with a sealing member at an outer edge. Various resins such as a thermosetting resin, a photocurable resin, a moisture-curable resin, and an anaerobic curable resin may be used for the sealing member, which is also called a sealing agent. Examples of the various resins include an epoxy resin, a urethane resin, an acrylic resin, an acetate vinyl resin, an ene-thiol resin, a silicone resin, and a modified polymer resin. However, the sealing member is not limited thereto. The optical apparatus and the light adjusting apparatus may be arranged in this order from an observer, or the light adjusting apparatus and the optical apparatus may be arranged in this order from the observer. Further, it is sufficient if a connector is attached to the light adjusting apparatus (specifically, a connector is attached to the first transparent electrode or the second transparent electrode), and the light adjusting apparatus is electrically connected to a control circuit (that corresponds to the light adjusting apparatus and the control circuit, and is included in the control apparatus 16 used to control the image forming apparatus) through the connector and wiring, the control circuit being used to control the light-shielding rate (the light transmittance) of the light adjusting apparatus. The light adjusting apparatus may be curved.

In the display apparatus or the like of the present disclosure including the light adjusting apparatus, an illuminance sensor (an environmental illuminance measurement sensor) that measures an illuminance in an environment in which the display apparatus is placed may be further included, and the light-shielding rate of the light adjusting apparatus may be controlled on the basis of a result of measurement performed by the illuminance sensor (the environmental illuminance measurement sensor). Further, an illuminance sensor (an environmental illuminance measurement sensor) that measures an illuminance in an environment in which the display apparatus is placed may be further included, and the brightness of an image formed by the image forming apparatus may be controlled on the basis of a result of measurement performed by the illuminance sensor (the environmental illuminance measurement sensor). These configurations may be adopted in combination.

Further, in the display apparatus or the like of the present disclosure including the light adjusting apparatus, a second illuminance sensor (that may be referred to as a “transmitted-light illuminance measurement sensor” for convenience) may be further included, the second illuminance sensor measuring an illuminance based on light that enters the light adjusting apparatus from an external environment to be transmitted through the light adjusting apparatus, and the light-shielding rate of the light adjusting apparatus may be controlled on the basis of a result of measurement performed by the second illuminance sensor (the transmitted-light illuminance measurement sensor).

Further, a second illuminance sensor (a transmitted-light illuminance measurement sensor) may be further included, the second illuminance sensor measuring an illuminance based on light that enters the light adjusting apparatus from an external environment to be transmitted through the light adjusting apparatus, and the brightness of an image formed by the image forming apparatus may be controlled on the basis of a result of measurement performed by the second illuminance sensor (the transmitted-light illuminance measurement sensor). It is favorable that the second illuminance sensor (the transmitted-light illuminance measurement sensor) be arranged closer to an observer than the optical apparatus. At least two second illuminance sensors (transmitted-light illuminance measurement sensors) may be arranged, and an illuminance based on light that passes through a portion having a high light-shielding rate, and an illuminance based on light that passes through a portion having a low light-shielding rate may be measured. These configurations may be adopted in combination. Further, these configurations may be adopted in combination with the above-described configurations in which control is performed on the basis of a result of measurement performed by the illuminance sensor (the environmental illuminance measurement sensor).

The illuminance sensor (the environmental illuminance measurement sensor and the transmitted-light illuminance measurement sensor) may be a well-known illuminance sensor, and the illuminance sensor may be controlled on the basis of a well-known control circuit.

The highest light transmittance of the light adjusting apparatus may be 50% or more, and the lowest light transmittance of the light adjusting apparatus may be 30% or less. The upper limit of the highest light transmittance of the light adjusting apparatus may be 99%, and the lower limit of the lowest light transmittance of the light adjusting apparatus may be 1%. Here, the following relationship is satisfied.

(light transmittance)=100(%)−(light-shielding rate)

In some cases, light that passes through the light adjusting apparatus may be given a desired color by the light adjusting apparatus, as described above. Further, in this case, the color given to the light by the light adjusting apparatus may be variable, or may be a fixed color. In the former case, it is sufficient if, for example, a light adjusting apparatus that turns light red, a light adjusting apparatus that turns light green, and a light adjusting apparatus that turns light blue are stacked. Further, in the latter case, examples of the color given to light by the light adjusting apparatus include, but is not limited to, brown.

An observer may observe the brightness of light that passes through the light adjusting apparatus and the optical apparatus, and the observer may manually control and adjust the light-shielding rate by operating, for example, a switch, a button, a dial, a slider, or a knob. Further, the light-shielding rate may be controlled and adjusted on the basis of a result of measurement performed by the above-described second illuminance sensor (transmitted-light illuminance measurement sensor) measuring an illuminance based on light that enters the light adjusting apparatus from an external environment to be transmitted through the light adjusting apparatus. Note that, specifically, it is sufficient if voltages respectively applied to the first transparent electrode and the second transparent electrode are controlled to control and adjust the light-shielding rate. At least two second illuminance sensors (transmitted-light illuminance measurement sensors) may be arranged, and an illuminance based on light that passes through a portion having a high light-shielding rate, and an illuminance based on light that passes through a portion having a low light-shielding rate may be measured. The display apparatus may include a single image display apparatus or two image display apparatuses. When two image display apparatuses are included, voltages applied to the first transparent electrode and the second transparent electrode are adjusted for each of the light adjusting apparatus of one of the two image display apparatuses and the light adjusting apparatus of another of the two image display apparatuses, and this makes it possible to equalize the light-shielding rate of the light adjusting apparatus of the one of the two image display apparatuses and the light-shielding rate of the light adjusting apparatus of the other of the two image display apparatuses. For example, the light-shielding rate of the light adjusting apparatus of the one of the two image display apparatuses and the light-shielding rate of the light adjusting apparatus of the other of the two image display apparatuses may be controlled on the basis of a result of measurement performed by the above-described second illuminance sensor (transmitted-light illuminance measurement sensor) measuring an illuminance based on light that enters the light adjusting apparatus from an external environment to be transmitted through the light adjusting apparatus. Further, an observer may observe the brightness of light that passes through the light adjusting apparatus and the optical apparatus of the one of the two image display apparatuses, and the brightness of light that passes through the light adjusting apparatus and the optical apparatus of the other of the two image display apparatuses, and the observer may manually control and adjust the light-shielding rates by operating, for example, a switch, a button, a dial, a slider, or a knob. When the light-shielding rate is adjusted, a test pattern may be displayed on the optical apparatus.

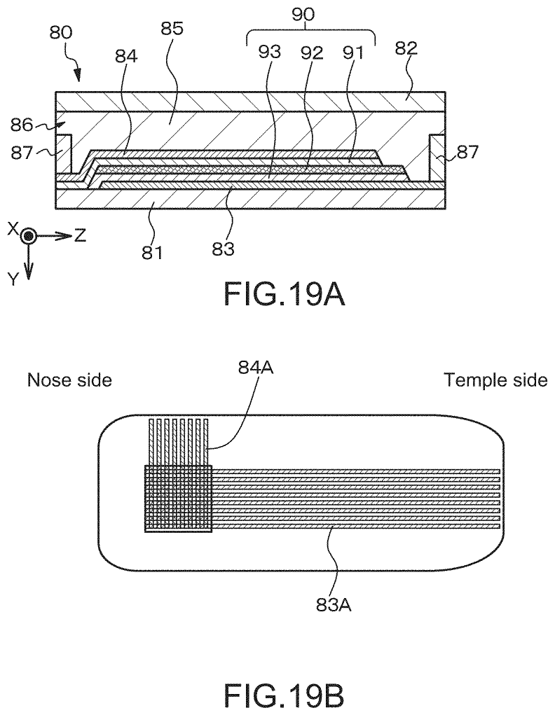

FIG. 19A is a schematic cross-sectional view of a light adjusting apparatus 80, and as illustrated in FIG. 19A, the light adjusting apparatus 80 includes
a first substrate 81,
a second substrate 82 that is arranged to face the first substrate 81, the second substrate 82 being a substrate that external light enters, and
a light-emitting stack that is arranged between the first substrate 81 and the second substrate 82, the light-emitting stack including a first transparent electrode 83, a light adjusting layer 90, and a second transparent electrode 84 that are stacked, as viewed from the first substrate, the light adjusting layer 90 having a stacking structure in which a reduction coloring layer 91, an electrolyte layer 92, and an oxidation coloring layer 93 are stacked.

In the fifth embodiment, the light adjusting apparatus 80 includes an optical shutter using a change in the color of a substance generated due to an oxidation-reduction reaction of an electrochromic material. Specifically, the light adjusting layer 90 includes an electrochromic material. In other words, the light adjusting layer 90 included in the light adjusting apparatus 80 includes an electrochromic material layer. Specifically, the light adjusting layer (the electrochromic material layer) 90 has a stacking structure in which the reduction coloring layer 91, the electrolyte layer 92, and the oxidation coloring layer 93 are stacked. More specifically, the first transparent electrode 83 and the second transparent electrode 84 are made of a transparent conductive material such as ITO or IZO, where the reduction coloring layer 91 is made of tungsten oxide (WO₃), the electrolyte layer 92 is made of tantalum oxide (Ta₂O₅), and the oxidation coloring layer 93 contains an iridium atom. An iridium oxide (IrOₓ) material, that is, specifically iridium tin oxide (Ir_{y}Sn_{1-y}Oₓ) is used in the fifth embodiment as a material of the oxidation reaction coloring layer 93 containing an iridium atom. Here, y=0.5. A color is given to a WO₃ layer due to reduction. A color is given to an Ir_{y}Sn_{1-y}Oₓ layer due to oxidation. A Ta₂O₅ layer is included in a solid electrolyte.

In the Ir_{y}Sn_{1-y}O layer, Ir and H₂O react to obtain iridium hydroxide Ir(OH)ₙ. When a negative potential is applied to the first transparent electrode 83 and a positive potential is applied to the second transparent electrode 84, a proton H⁺ is transferred from the Ir_{y}Sn_{1-y}O layer to the Ta₂O₅ layer, an electron is emitted to the second transparent electrode 84, and a subsequent oxidation reaction is begun to give a color to the Ir_{y}Sn_{1-y}O layer.

Ir(OH)ₙ→IrO_{X}(OH)_{n-X} (with color)+X·H⁺+X·e⁻

On the other hand, the proton H⁺ in the Ta₂O₅ layer is transferred to the WO₃ layer, an electron is injected into the WO₃ layer from the first transparent electrode 83, and a subsequent reduction reaction is begun in the WO₃ layer to give a color to the WO₃ layer.

WO₃+X·H⁺+X·e⁻→H_{X}WO₃ (with color)

Conversely, a positive potential is applied to the first transparent electrode 83 and a negative potential is applied to the second transparent electrode 84. Then, in the Ir_{y}Sn_{1-y}O layer, a reduction reaction is begun in a direction opposite to the direction in the description above, and the color disappears. In the WO₃ layer, an oxidation reaction is begun in a direction opposite to the direction in the description above, and the color disappears. The Ta₂O₅ layer contains H₂O, which is ionized by applying voltages to the first transparent electrode 83 and the second transparent electrode 84, and a state of a proton H⁺ and an OH⁻ ion is generated. This contributes toward the coloring reaction and the achromatization reaction.

The first substrate 81 and the second substrate 82 are made of a plastic material. Specifically, the first substrate 81 and the second substrate 82 are made of, for example, a polycarbonate resin of a thickness of 0.3 mm. A hard coat layer (not illustrated) that includes acrylic modified colloidal silica particles, phenyl ketone organic matter, acrylate organic matter, and methyl ethyl ketone is formed on an outer face of the second substrate 82.

In the fifth embodiment, the optical apparatus 40 overlaps at least a portion of the light adjusting apparatus 80, which is a type of optical shutter. Specifically, the optical apparatus 40 overlaps the light adjusting apparatus 80. In other words, the light guiding plate 41, 41′, the first substrate 81, and the second substrate 82 have the same (or substantially the same) outer shape. The light adjusting apparatus 80 overlaps a large portion of the light guiding plate 41, 41′. However, the configuration is not limited thereto, and the optical apparatus 40 may overlap a portion of the light adjusting apparatus 80, or the light adjusting apparatus 80 may overlap a portion of the optical apparatus 40. Further, the light adjusting apparatus 80 and the optical apparatus 40 are arranged in this order, as viewed from an observer, but the light adjusting apparatus 80 and the optical apparatus 40 may be arranged in this order, as viewed from the observer.

Further, a moisture holding member 85 is arranged at least between the second transparent electrode 84 and the second substrate 82. Furthermore, an end surface of the moisture holding member 85 is exposed to the outside. At least a portion of an end (a side surface) of the light adjusting apparatus 80 is formed of a sealing member 87 and the moisture holding member 85 in this order, as viewed from the first substrate. In other words, at least a portion of the end of the light adjusting apparatus 80 is formed of a stacking structure in which the sealing member 87, and a moisture-holding-member extension 86 that extends from the moisture holding member 85 are stacked, as viewed from the first substrate. For example, the sealing member 87 is provided at an edge of the first substrate 81.

Further, the second transparent electrode 84 is formed to extend from a top of the light adjusting layer 90 to a top of the first substrate 81, and is spaced from the first transparent electrode 83. The moisture holding member 85 covers at least the second transparent electrode 84 and the light adjusting layer 90. In other words, the first transparent electrode 83 is formed on the first substrate 81, the light adjusting layer 90 is formed on the first transparent electrode 83, the second transparent electrode 84 is formed at least on the light adjusting layer 90, and the moisture holding member 85 covers at least the second transparent electrode 84 and faces the second substrate 82. The moisture-holding-member extension 86 extending from the moisture holding member 85 is arranged between the sealing member 87 and the second substrate 82. Further, a portion of the sealing member 87 includes an auxiliary electrode (not illustrated) that is made of copper (Cu). Furthermore, the rest of the sealing member 87 is made of resin, that is, an acrylic adhesive in particular. The auxiliary electrode includes a first auxiliary electrode that is formed on the first transparent electrode 83, and a second auxiliary electrode that is formed on the second transparent electrode 84 to be spaced from the first auxiliary electrode. A sidewall of the light adjusting apparatus 80 is formed of the sealing member 87 and the moisture-holding-member extension 86. Further, the sealing member 87 is provided with no space.

It is sufficient if a resin used for the moisture holding member 85 and the moisture-holding-member extension 86, which may also be referred to as a proton supply member, or a transparent adhesive member that can hold moisture, or a transparent sealing member that can hold moisture, is selected from an acrylic resin, a silicone resin, and a urethane resin as appropriate. Specifically, the moisture holding member 85 and the moisture-holding-member extension 86 are made of an acrylic resin in the fifth embodiment.

When the moisture holding member 85 and the moisture-holding-member extension 86 are made of a material of which the Young's modulus is 1×10⁶ Pa or less, this makes it possible to eliminate various differences in level that are caused in the light adjusting apparatus, and to reduce a variation in the thickness of the moisture holding member 85 in a center portion of the light adjusting apparatus, and a variation in the thickness of the moisture-holding-member extension 86 in the center portion of the light adjusting apparatus. In other words, a distance between the first substrate 81 and the second substrate 82 can be made constant in the entirety of the light adjusting apparatus. This results in being able to prevent the visibility from being decreased. Specifically, this makes it possible to prevent a distortion or a deviation in an image of the outside world upon seeing the outside world through the light adjusting apparatus 80.

The first transparent electrode 83 and the second transparent electrode 84 being made of ITO are not patterned, and are so-called solid-pattern electrodes. A connector (not illustrated) is attached to a portion of each auxiliary electrode of the light adjusting apparatus 80, and the first transparent electrode 83 and the second transparent electrode 84 are electrically connected to a control circuit (specifically, the control apparatus 16) that is used to control the light-shielding rate of the light adjusting apparatus 80.

When there is no moisture in an electrochromic element, the color of the electrochromic element will not be changed. However, moisture enters and exits the light adjusting apparatus of the fifth embodiment through an end surface of the moisture-holding-member extension (the sidewall of the light adjusting apparatus). This makes it possible to prevent the reliability of the light adjusting apparatus, the image display apparatus, or the display apparatus from being decreased. Further, the provision of an auxiliary electrode makes it possible to easily apply an appropriate voltage to each of the first transparent electrode and the second transparent electrode, and to prevent voltage from dropping in the first transparent electrode or the second transparent electrode. Consequently, color unevenness caused when a color is given by the light adjusting apparatus can be reduced.

The light adjusting apparatus 80 may be in an operating state at all times, an operating/non-operating (on/off) state of the light adjusting apparatus 80 may be defined using an instruction (operation) of an observer, or the light adjusting apparatus 80 may be normally in a non-operating state, and may start operating on the basis of a signal used to display an image on the image display apparatus 20. In order to define the operation/non-operation state using an instruction (operation) of an observer, it is sufficient if, for example, the display apparatus further includes a microphone, and the operation of the light adjusting apparatus 80 may be controlled by inputting sound through the microphone. Specifically, a switching between the operation and the non-operation of the light adjusting apparatus 80 may be controlled by an instruction given by an observer using his/her actual voice. Further, information to be obtained may be input by inputting sound. Furthermore, it is sufficient if the display apparatus further includes an infrared input/output apparatus, and the operation of the light adjusting apparatus 80 may be controlled by the infrared input/output apparatus. Specifically, it is sufficient if a switching between the operation and the non-operation of the light adjusting apparatus 80 is controlled by detecting a blink of an observer using the infrared input/output apparatus.

Since the display apparatus of the fifth embodiment includes the light adjusting apparatus, a high contrast can be provided to a virtual image observed by an observer. Further, the observer who is using the display apparatus can recognize an external environment through the optical apparatus with certainty.

In some cases, the first transparent electrode and/or the second transparent electrode may be divided into a plurality of blocks, and the light-shielding rate of each block may be controlled to control the light-shielding rate of each region of the light adjusting apparatus. Further, the first transparent electrode or the second transparent electrode may be a strip-shaped electrode or a mesh electrode, or a strip-shaped auxiliary electrode or a mesh auxiliary electrode may be formed on the first transparent electrode or the second transparent electrode to independently control the light-shielding rates of a plurality of regions of the light adjusting apparatus. In some cases, the light adjusting apparatus may include, for example, a liquid crystal display apparatus driven on the basis of active matrix or passive matrix to control the light-shielding rate of the light adjusting apparatus.

The light-shielding rate of the light adjusting apparatus 80 may be controlled on the basis of, for example, passive matrix. In other words, FIG. 19B is a schematic plan view of a modification of the light adjusting apparatus 80, and as illustrated in FIG. 19B,
the first transparent electrode 83 includes a plurality of strip-shaped first transparent electrode segments 83A each extending in a first direction,
the second transparent electrode 84 includes a plurality of strip-shaped second transparent electrode segments 84A each extending in a second direction that is different from the first direction, and
the light-shielding rate of a portion of the light adjusting apparatus that corresponds to a region in which the first transparent electrode segment 83A and the second transparent electrode segment 84A overlap (a smallest-unit region in which the light-shielding rate of the light adjusting apparatus is changed) is controlled by voltages applied to the first transparent electrode segment 83A and the second transparent electrode segment 84A being controlled. The first direction and the second direction are orthogonal to each other, and specifically, the first direction extends in a lateral direction (an X direction), and the second direction extends in a longitudinal direction (a Y direction). There is no need for an auxiliary electrode in such a configuration.

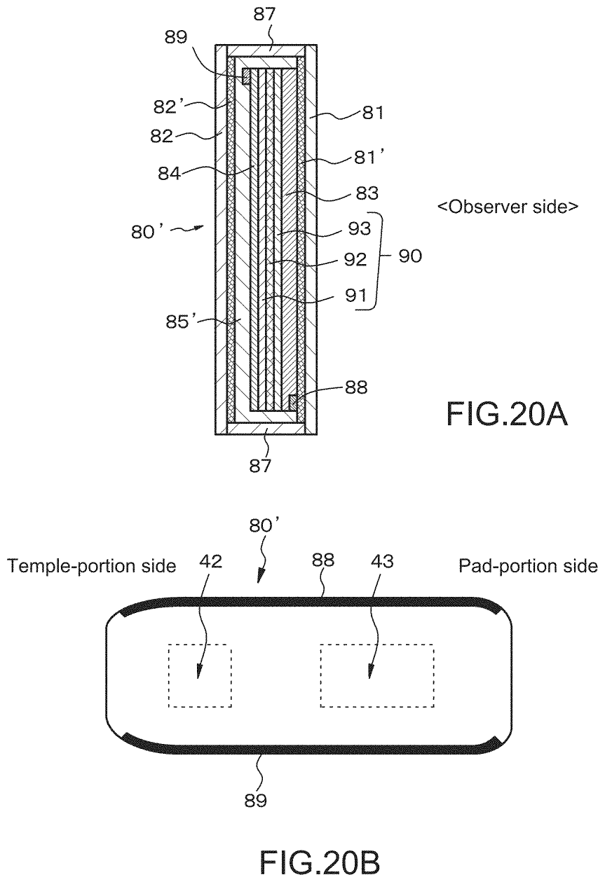

Further, FIG. 20A is a schematic cross-sectional view of another modification of a light adjusting apparatus 80′, and FIG. 20B is a schematic front view of the other modification of the light adjusting apparatus 80′. The configurations and the structures of the first substrate 81, the second substrate 82, the light-emitting stack (the first transparent electrode 83, the light adjusting layer 90, and the second transparent electrode 84), the light adjusting layer 90 (the reduction coloring layer 91, the electrolyte layer 92, and the oxidation coloring layer 93), and the sealing member 87 of the light adjusting apparatus 80′, are similar to the configurations and the structures of those structural elements of the light adjusting apparatus 80 of the fifth embodiment described above. In the schematic cross-sectional view of the light adjusting apparatus 80′ illustrated in FIG. 20A, the first and second auxiliary electrodes of which illustrations are omitted in FIG. 19A, are respectively denoted by reference numeral 88 and reference numeral 89. Further, in the schematic cross-sectional view of the light adjusting apparatus 80′ illustrated in FIG. 20A, barrier layers (that are made of, for example, an inorganic material, that is, alumina in particular) of which illustrations are omitted in FIG. 19A, are denoted by reference numeral 81′ and reference numeral 82′. Further, a protection layer 85′ that includes a SiN layer, a SiO₂ layer, an Al₂O₃ layer, a TiO₂ layer, or film stacks in which those layers are stacked. The formation of the protection layer 85′ makes it possible to impart, to the light adjusting apparatus, ion blocking properties, waterproof properties, dampproof properties, and damage prevention properties that block ions from passing through the light adjusting apparatus.

The optical apparatus 40 overlaps the light adjusting apparatus 80′. In other words, the light guiding plate 41, 41′, the first substrate 81, and the second substrate 82 have the same (or substantially the same) outer shape. The first transparent electrode 83 and the second transparent electrode 84 being made of ITO are not patterned, and are so-called solid-pattern electrodes. A connector (not illustrated) is attached to a portion of each of the auxiliary electrodes 88 and 89 of the light adjusting apparatus 80′, and the first transparent electrode 83 and the second transparent electrode 84 are electrically connected to a control circuit (specifically, the control apparatus 16) that is used to control the light-shielding rate of the light adjusting apparatus 80′.

The present disclosure has been described above on the basis of the favorable embodiments. However, the present disclosure is not limited to these embodiments. The configurations and the structures of the display apparatus (the head-mounted display), the image display apparatus, and the optical apparatus described in the embodiments are merely illustrative, and modifications may be made thereto as appropriate. In the embodiments, the display apparatus is a binocular display apparatus that includes a right-eye image display apparatus and a left-eye image display apparatus. However, the display apparatus may be a display apparatus that includes the image display apparatus of the present disclosure, that is, a monocular display apparatus. In the embodiments, the substrate included in the light guiding plate is made of a resin material, but alternatively, a glass substrate for which surface-polishing processes have been simplified, compared to a glass substrate of which the quality is precisely controlled, that is, specifically, a standard-quality glass substrate (an optical glass substrate) with Rq of about 5 nm may be used. When the surface-polishing processes are simplified, as described above, an optical apparatus that can provide a contrast and a resolution as high as a contrast and a resolution that are provided by conventional optical apparatuses, and a display apparatus that includes the optical apparatus can be provided at low costs.

Further, for example, a surface relief hologram (refer to US 2004/0062505 A1) may be provided to the light guiding plate, or the surface relief grating disclosed in U.S. Pat. No. 9,513,480 B2 (US 2016/0231568 A1) may be used as the diffraction grating member. One of the first deflection mechanism and the second deflection mechanism may include a reflective diffraction grating member, and the other may include a transmissive diffraction grating member. Further, the diffraction grating member may be a reflective blazed diffraction grating member, or the hologram diffraction grating member may include the polymer-dispersed liquid crystal (PDLC) mixture disclosed in Japanese Patent Application Laid-open No. 2014-132328.

The example in which the image forming apparatus displays an image in one color (for example, blue) has been described in the embodiments, but the image forming apparatus can also display a color image. In this case, it is sufficient if the light source includes a light source that emits red light, a light source that emits green light, and a light source that emits blue light. More specifically, it is sufficient, for example, red light, green light, and blue light that are respectively emitted by a red-light-emitting element, a green-light-emitting element, and a blue-light-emitting element may be mixed and the brightness may be made uniform using a light pipe to obtain white light.

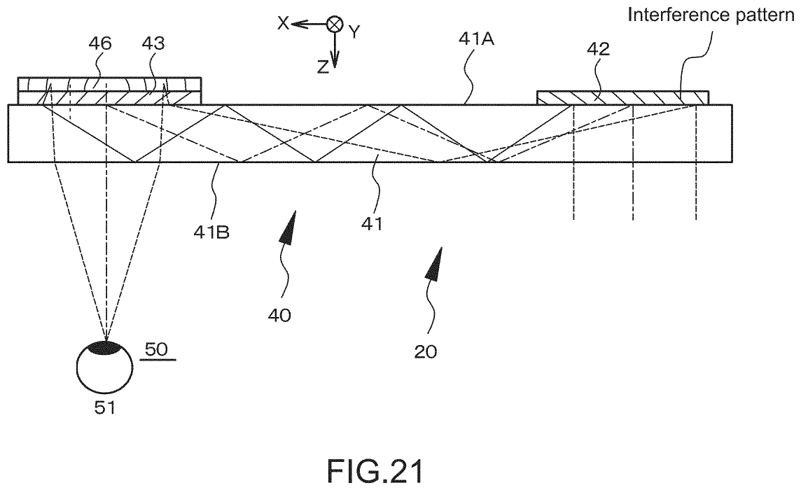

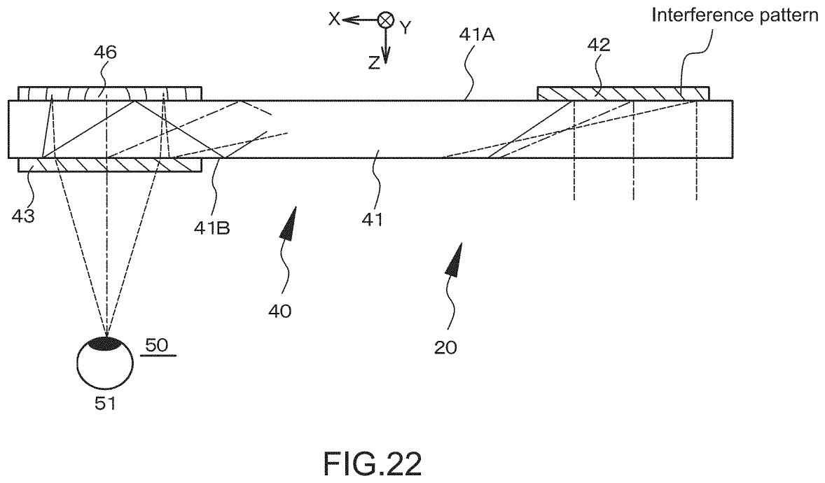

FIGS. 21 and 22 illustrate modifications of the optical apparatus illustrated in the second or third embodiment. An optical member 46 may be arranged on the optical apparatus 40 to face the second deflection mechanism 43. Light from the image forming apparatus 30 is deflected by (or reflected off) the first deflection mechanism 42, and is internally totally reflected off the light guiding plate 41 to propagate through the light guiding plate 41. The light is deflected by the second deflection mechanism 43 to enter the optical member 46, and exits the optical member 46 to be headed for the pupil 51 of the observer 50. A large portion of light passing through the second deflection mechanism 43 does not satisfy the diffraction condition for the second deflection mechanism 43. Thus, the light enters the pupil 51 of the observer 50 without being diffractively reflected off the second deflection mechanism 43. The optical member 46 includes, for example, a hologram lens, and is arranged on, for example, the side of the first surface of the light guiding plate 41. The second deflection mechanism 43 is arranged on the side of the first surface of the light guiding plate 41 (refer to FIG. 21) or on the side of the second surface of the light guiding plate 41 (refer to FIG. 22).

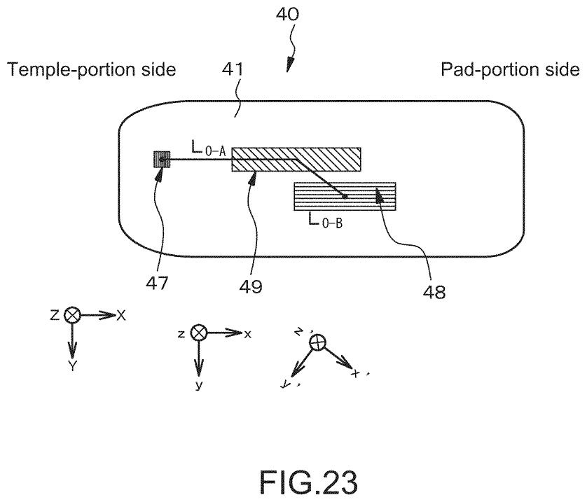

Modifications described below may be made to the optical apparatus described in the second or third embodiment. In other words, FIG. 23 illustrates a conceptual diagram of the optical apparatus, and as illustrated in FIG. 23, a first reflective volume-hologram diffraction grating member 47, a second reflective volume-hologram diffraction grating member 48, and a third reflective volume-hologram diffraction grating member 49 may be included. In the first reflective volume-hologram diffraction grating member 47, an interference pattern of a diffraction grating member extends substantially parallel to a Y axis (a y axis). In the second reflective volume-hologram diffraction grating member 48, an interference pattern of a diffraction grating member extends substantially parallel to an X axis (an×axis). In the third reflective volume-hologram diffraction grating member 49, an interference pattern of a diffraction grating member extends obliquely (in a y′ direction). A light ray exiting the image forming apparatus 30 is diffracted in an X-axis direction by the first reflective volume-hologram diffraction grating member 47, propagates through the light guiding plate 41, and enters the third reflective volume-hologram diffraction grating member 49. Then, the light ray is diffracted obliquely downward by the third reflective volume-hologram diffraction grating member 49, and enters the second reflective volume-hologram diffraction grating member 48. Then, the light ray is diffracted in a Z-axis direction by the second reflective volume-hologram diffraction grating member 48, and enters the pupil 51 of the observer 50. A line that connects an entrance point and an exit point includes two lines L_{0-A} and L_{0-B}. A light-guiding region includes two regions that are
[A] a region, in the light guiding plate 41, that faces a region situated between a right end of the first reflective volume-hologram diffraction grating member 47 in FIG. 23 and a left end of the third reflective volume-hologram diffraction grating member 49 in FIG. 23, and
[B] a region, in the light guiding plate 41, that faces a region situated between a lower end of the third reflective volume-hologram diffraction grating member 49 in FIG. 23 and an upper end of the second reflective volume-hologram diffraction grating member 48 in FIG. 23.

Further, the entirety of the light-guiding region includes the two regions in the light guiding plate 41 described above,
[C] a region, in the light guiding plate 41, that faces the first reflective volume-hologram diffraction grating member 47,
[D] a region, in the light guiding plate 41, that faces the third reflective volume-hologram diffraction grating member 49, and
[E] a region, in the light guiding plate 41, that faces the second reflective volume-hologram diffraction grating member 48.

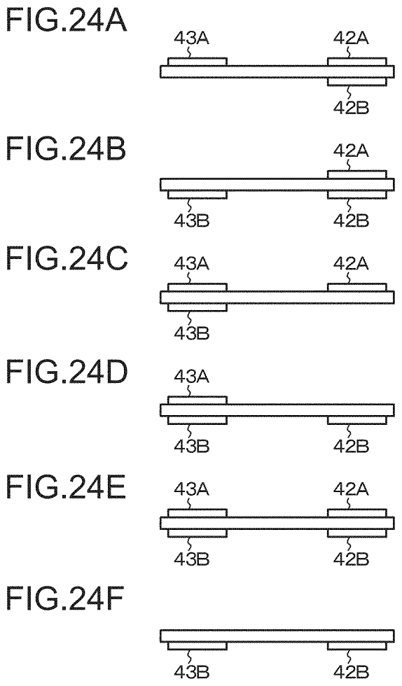

Further, modifications described below may be made to the optical apparatus described in the second and third embodiments. In other words, as illustrated in a conceptual diagram of FIG. 24A, a hologram diffraction grating member on a light entrance side may include a reflective diffraction grating member 42A and a transmissive diffraction grating member 42B, and a hologram diffraction grating member on a light exit side may include a reflective diffraction grating member 43A. Further, as illustrated in a conceptual diagram of FIG. 24B, the hologram diffraction grating member on the light entrance side may include the reflective diffraction grating member 42A and the transmissive diffraction grating member 42B, and the hologram diffraction grating member on the light exit side may include a transmissive diffraction grating member 43B. Furthermore, as illustrated in a conceptual diagram of FIG. 24C, the hologram diffraction grating member on the light entrance side may include the reflective diffraction grating member 42A, and the hologram diffraction grating member on the light exit side may include the reflective diffraction grating member 43A and the transmissive diffraction grating member 43B. Moreover, as illustrated in a conceptual diagram of FIG. 24D, the hologram diffraction grating member on the light entrance side may include the transmissive diffraction grating member 42B, and the hologram diffraction grating member on the light exit side may include the reflective diffraction grating member 43A and the transmissive diffraction grating member 43B. Further, as illustrated in a conceptual diagram of FIG. 24E, the hologram diffraction grating member on the light entrance side may include the reflective diffraction grating member 42A and the transmissive diffraction grating member 42B, and the hologram diffraction grating member on the light exit side may include the reflective diffraction grating member 43A and the transmissive diffraction grating member 43B. Furthermore, as illustrated in a conceptual diagram of FIG. 24F, the hologram diffraction grating member on the light entrance side may include the transmissive diffraction grating member 42B, and the hologram diffraction grating member on the light exit side may include the transmissive diffraction grating member 43B.

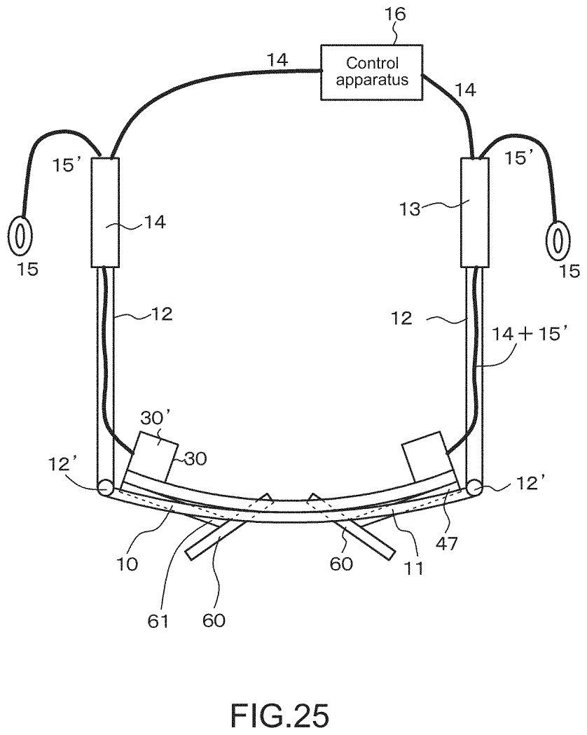

Further, modifications described below may be made to the optical apparatus described in the second and third embodiments. In other words, as illustrated in a conceptual diagram of FIG. 25, the optical apparatus includes a semi-transmissive mirror, where light exiting the image forming apparatus 30 enters the semi-transmissive mirror and exits the semi-transmissive mirror to be headed for the pupil 51 of the observer 50. Note that, in FIG. 25, the light exiting the image forming apparatus 30 propagates through a transparent member 61 such as a glass plate or a plastic plate, and enters an optical apparatus 60 (a semi-transmissive mirror). However, the light may propagate through the air, and may enter the optical apparatus 60. Further, the example in which the two temple portions 12 respectively extending from the two ends of the front portion 11 are connected to the front portion 11 through respective hinges 12′, is illustrated in the figure, but the configuration is not limited thereto.

Note that the present disclosure may also take the following configurations.
[A01] <<Display Apparatus: First Aspect>>
   A display apparatus, including:
   a frame; and
   a right-eye image display apparatus and a left-eye image display apparatus that are attached to the frame,
   each of the image display apparatuses including
      an image forming apparatus, and
      an optical apparatus that guides an image coming from the image forming apparatus to a pupil of an observer,
   the optical apparatus including
      a light guiding plate,
      a first deflection mechanism that is attached to the light guiding plate, and
      a second deflection mechanism that is attached to the light guiding plate, in which
   the image coming from the image forming apparatus enters the first deflection mechanism, is deflected by the first deflection mechanism, is guided through the light guiding plate, enters the second deflection mechanism, is deflected by the second deflection mechanism, and enters the pupil of the observer, and
   when a central ray that exits from a center point of an image forming region in the image forming apparatus, is deflected by the second deflection mechanism to enter the pupil of the observer, and when a point, on the light guiding plate, at which the central ray exits the light guiding plate is an origin, and when, in an XYZ orthogonal coordinate system of which axes of X, Y, and Z pass through the origin, an axis of the light guiding plate that passes through the origin is an X axis, an axis that passes through the origin and extends in parallel with a normal line of the light guiding plate is a Z axis, and an axis that is orthogonal to the X and Z axes is a Y axis, the central ray enters from a position closer to the image forming apparatus (from a position closer to a right ear of the observer in the case of the right-eye image forming apparatus, and from a position closer to a left ear of the observer in the case of the left-eye image forming apparatus) than an imaginary vertical plane that includes a pupillary axis and is parallel to the Y axis.
[A02] <<Display Apparatus: Second Aspect>>
   A display apparatus, including:
   a frame; and
   a right-eye image display apparatus and a left-eye image display apparatus that are attached to the frame,
   each of the image display apparatuses including
      an image forming apparatus, and
      an optical apparatus that guides an image coming from the image forming apparatus to a pupil of an observer,
   the optical apparatus including
      a light guiding plate,
      a first deflection mechanism that is attached to the light guiding plate, and
      a second deflection mechanism that is attached to the light guiding plate, in which
   the image coming from the image forming apparatus enters the first deflection mechanism, is deflected by the first deflection mechanism, is guided through the light guiding plate, enters the second deflection mechanism, is deflected by the second deflection mechanism, and enters the pupil of the observer, and
   an image that is formed by the right-eye image display apparatus and an image that is formed by the left-eye image display apparatus are not fused with each other.
[A03] The display apparatus according to [A01] or [A02], in which
   α>0 degrees is satisfied when α is an angle formed by the pupillary axis and an orthogonal projection image obtained by orthogonally projecting the central ray onto an XZ plane.
[A04] The display apparatus according to [A03], in which
   α≥5 degrees is satisfied.
[A05] The display apparatus according to [A03] or [A04], in which
   α>β is satisfied when 2β is an angle formed by a first-light-ray orthogonal projection image and a second-light-ray orthogonal projection image, the first-light-ray orthogonal projection image being obtained by orthogonally projecting a first light ray onto the XZ plane, the first light ray exiting an ear-side end of the image forming apparatus that is situated in an imaginary XZ plane in the image forming apparatus, and entering the pupil of the observer, the imaginary XZ plane corresponding to the XZ plane, the second-light-ray orthogonal projection image being obtained by orthogonally projecting a second light ray onto the XZ plane, the second light ray exiting a nose-side end of the image forming apparatus that is situated in the imaginary XZ plane, and entering the pupil of the observer.
[A06] The display apparatus according to any one of [A01] to [A06], in which
   0 degrees≤θ₀≤30 degrees is satisfied when an angle formed by the pupillary axis and the normal line of the light guiding plate is θ₀, the normal line passing through an intersection of the pupillary axis and the light guiding plate.
[A07] The display apparatus according to any one of [A01] to [A06], in which
   when the central ray enters the light guiding plate at an angle of incidence θᵢₙ and exits the light guiding plate at an exit angle θₒᵤₜ, the angle of incidence θᵢₙ and the exit angle θₒᵤₜ exhibit the same value, and a direction at the angle of incidence θᵢₙ relative to the light guiding plate and a direction at the exit angle θₒᵤₜ relative to the light guiding plate are different from each other.
[A08] The display apparatus according to any one of [A01] to [A07], in which
   from among light rays exiting the image forming apparatus, a portion of light rays situated on a side of an ear of the observer is not deflected by the first deflection mechanism.
[A09] The display apparatus according to any one of [A01] to [A08], in which
   a slant angle in the first deflection mechanism differs between a region, in the first deflection mechanism, that is situated on a side of an ear of the observer and a region, in the first deflection mechanism, that is situated on a side of a nose of the observer, and
   a slant angle in the second deflection mechanism differs between a region, in the second deflection mechanism, that is situated on the side of the nose of the observer and a region, in the second deflection mechanism, that is situated on the side of the ear of the observer.
[A10] The display apparatus according to any one of [A01] to [A09], in which
   an image that exits the image forming apparatus of the right-eye image display apparatus and an image that exits the image forming apparatus of the left-eye image display apparatus are different images.
[A11] The display apparatus according to any one of [A01] to [A10], in which
   an image that exits the image forming apparatus of the right-eye image display apparatus is observed on a side of the right ear of the observer, and an image that exits the image forming apparatus of the left-eye image display apparatus is observed on a side of the left ear of the observer.
[A12] The display apparatus according to any one of [A01] to [A11], in which
   an image that exits the image forming apparatus of the right-eye image display apparatus and an image that exits the image forming apparatus of the left-eye image display apparatus are not fused with each other.
[B01] <<Display Apparatus: Third Aspect>>
   A display apparatus, including:
   a frame; and
   an image display apparatus that is attached to the frame,
   the image display apparatus including
      an image forming apparatus, and
      an optical apparatus that guides an image coming from the image forming apparatus to a pupil of an observer,
   the optical apparatus including
      a light guiding plate,
      a first deflection mechanism that is attached to the light guiding plate, and
      a second deflection mechanism that is attached to the light guiding plate, in which
   the image coming from the image forming apparatus enters the first deflection mechanism, is deflected by the first deflection mechanism, is guided through the light guiding plate, enters the second deflection mechanism, is deflected by the second deflection mechanism, and enters the pupil of the observer, and
   when a central ray that exits from a center point of an image forming region in the image forming apparatus, is deflected by the second deflection mechanism to enter the pupil of the observer, and when a point, on the light guiding plate, at which the central ray exits the light guiding plate is an origin, and when, in an XYZ orthogonal coordinate system of which axes of X, Y, and Z pass through the origin, an axis of the light guiding plate that passes through the origin is an X axis, an axis that passes through the origin and extends in parallel with a normal line of the light guiding plate is a Z axis, and an axis that is orthogonal to the X and Z axes is a Y axis, the central ray enters from a position closer to the image forming apparatus (from a position closer to an ear of the observer) than an imaginary vertical plane that includes a pupillary axis and is parallel to the Y axis.
[B02] The display apparatus according to [B01], in which
   α>0 degrees is satisfied when α is an angle formed by the pupillary axis and an orthogonal projection image obtained by orthogonally projecting the central ray onto an XZ plane.
[B03] The display apparatus according to [B02], in which
   α≥5 degrees is satisfied.
[B04] The display apparatus according to [B02] or [B03], in which
   when 2β is an angle formed by a first-light-ray orthogonal projection image and a second-light-ray orthogonal projection image, the first-light-ray orthogonal projection image being obtained by orthogonally projecting a first light ray onto the XZ plane, the first light ray exiting an ear-side end of the image forming apparatus that is situated in an imaginary XZ plane in the image forming apparatus, and entering the pupil of the observer, the imaginary XZ plane corresponding to the XZ plane, the second-light-ray orthogonal projection image being obtained by orthogonally projecting a second light ray onto the XZ plane, the second light ray exiting a nose-side end of the image forming apparatus that is situated in the imaginary XZ plane, and entering the pupil of the observer,
   α>β is satisfied in the case in which the first light ray enters the pupil of the observer from a position closer to the ear of the observer than the pupillary axis, and (β−α)≤5 degrees is satisfied in the case in which the first light ray enters the pupil of the observer from a position closer to a nose of the observer than the pupillary axis.
[B05] The display apparatus according to any one of [A01] to [B05], in which
   0 degrees≤θ₀≤30 degrees is satisfied when an angle formed by the pupillary axis and the normal line of the light guiding plate is θ₀, the normal line passing through an intersection of the pupillary axis and the light guiding plate.
[B06] The display apparatus according to any one of [A01] to [B05], in which
   when the central ray enters the light guiding plate at an angle of incidence θᵢₙ and exits the light guiding plate at an exit angle θeₒᵤₜ, the angle of incidence θᵢₙ and the exit angle θₒᵤₜ exhibit the same value, and a direction at the angle of incidence θᵢₙ relative to the light guiding plate and a direction at the exit angle θₒᵤₜ relative to the light guiding plate are different from each other.
[B07] The display apparatus according to any one of [A01] to [B06], in which
   from among light rays exiting the image forming apparatus, a portion of light rays situated on a side of the ear of the observer is not deflected by the first deflection mechanism.
[B08] The display apparatus according to any one of [A01] to [B07], in which
   a slant angle in the first deflection mechanism differs between a region, in the first deflection mechanism, that is situated on a side of the ear of the observer and a region, in the first deflection mechanism, that is situated on a side of a nose of the observer, and
   a slant angle in the second deflection mechanism differs between a region, in the second deflection mechanism, that is situated on the side of the nose of the observer and a region, in the second deflection mechanism, that is situated on the side of the ear of the observer.
[C01] <<Image Display Apparatus>>
   An image display apparatus, including:
   an image forming apparatus; and
   an optical apparatus that guides an image coming from the image forming apparatus to a pupil of an observer,
   the optical apparatus including
      a light guiding plate,
      a first deflection mechanism that is attached to the light guiding plate, and
      a second deflection mechanism that is attached to the light guiding plate, in which
   the image coming from the image forming apparatus enters the first deflection mechanism, is deflected by the first deflection mechanism, is guided through the light guiding plate, enters the second deflection mechanism, is deflected by the second deflection mechanism, and enters the pupil of the observer, and
   when a central ray that exits from a center point of an image forming region in the image forming apparatus, is deflected by the second deflection mechanism to enter the pupil of the observer, and when a point, on the light guiding plate, at which the central ray exits the light guiding plate is an origin, and when, in an XYZ orthogonal coordinate system of which axes of X, Y, and Z pass through the origin, an axis of the light guiding plate that passes through the origin is an X axis, an axis that passes through the origin and extends in parallel with a normal line of the light guiding plate is a Z axis, and an axis that is orthogonal to the X and Z axes is a Y axis, the central ray enters from a position closer to the image forming apparatus (from a position closer to a right ear of the observer in the case of the right-eye image forming apparatus, and from a position closer to a left ear of the observer in the case of the left-eye image forming apparatus) than an imaginary vertical plane that includes a pupillary axis and is parallel to the Y axis.
[C02] The image display apparatus according to [C01], in which
   α>0 degrees is satisfied when α is an angle formed by the pupillary axis and an orthogonal projection image obtained by orthogonally projecting the central ray onto an XZ plane.
[C03] The display apparatus according to [C02], in which
   α≤5 degrees is satisfied.
[C04] The image display apparatus according to [C02] or [C03], in which
   when 2β is an angle formed by a first-light-ray orthogonal projection image and a second-light-ray orthogonal projection image, the first-light-ray orthogonal projection image being obtained by orthogonally projecting a first light ray onto the XZ plane, the first light ray exiting an ear-side end of the image forming apparatus that is situated in an imaginary XZ plane in the image forming apparatus, and entering the pupil of the observer, the imaginary XZ plane corresponding to the XZ plane, the second-light-ray orthogonal projection image being obtained by orthogonally projecting a second light ray onto the XZ plane, the second light ray exiting a nose-side end of the image forming apparatus that is situated in the imaginary XZ plane, and entering the pupil of the observer,
   α>β is satisfied in the case in which the first light ray enters the pupil of the observer from a position closer to an ear of the observer than the pupillary axis, and (β−α)≤5 degrees is satisfied in the case in which the first light ray enters the pupil of the observer from a position closer to a nose of the observer than the pupillary axis.
[C05] The image display apparatus according to any one of [A01] to [C05], in which
   0 degrees≤θ₀≤30 degrees is satisfied when an angle formed by the pupillary axis and the normal line of the light guiding plate is θ₀, the normal line passing through an intersection of the pupillary axis and the light guiding plate.
[C06] The image display apparatus according to any one of [A01] to [C05], in which
   when the central ray enters the light guiding plate at an angle of incidence θᵢₙ and exits the light guiding plate at an exit angle θeₒᵤₜ, the angle of incidence θᵢₙ and the exit angle θₒᵤₜ exhibit the same value, and a direction at the angle of incidence θᵢₙ relative to the light guiding plate and a direction at the exit angle θₒᵤₜ relative to the light guiding plate are different from each other.
[C07] The image display apparatus according to any one of [A01] to [C06], in which
   from among light rays exiting the image forming apparatus, a portion of light rays situated on a side of an ear of the observer is not deflected by the first deflection mechanism.
[C08] The image display apparatus according to any one of [A01] to [C07], in which
   a slant angle in the first deflection mechanism differs between a region, in the first deflection mechanism, that is situated on a side of an ear of the observer and a region, in the first deflection mechanism, that is situated on a side of a nose of the observer, and
   a slant angle in the second deflection mechanism differs between a region, in the second deflection mechanism, that is situated on the side of the nose of the observer and a region, in the second deflection mechanism, that is situated on the side of the ear of the observer.

### REFERENCE SIGNS LIST

10 frame
11 front portion
12 temple portion
12′ hinge
13 temple-tip covering portion (celluloid tip portion, ear-fit portion, ear pad)
14 wiring (such as signal line and power supply line)
15 headphone portion
15′ headphone-portion wiring
16 control apparatus (control circuit, control mechanism)
17 nose pad portion
20 image display apparatus
30 image forming apparatus
30′ housing
30E ear-side end of image forming apparatus
30N nose-side end of image forming apparatus
31A housing
31B organic EL display apparatus
31C first convex lens
31D diaphragm
31E second convex lens
32A housing
32B light source
32C polarization beam splitter
32D liquid crystal display apparatus (LCD)
32E optical system (parallel-light output optical system, collimating optical system)
33A housing
33B light source
33C scanning mechanism
33D lens system
40, 60 optical apparatus
40A end of optical apparatus
41, 41′ light guiding plate
41A first surface of light guiding plate
41B second surface of light guiding plate
42, 42′, 42A, 42B, 42C first deflection mechanism (first diffraction grating member)
43, 43′, 43A, 43B, 43C second deflection mechanism (second diffraction grating member)
44 portion, in light guiding plate, to which first deflection mechanism is provided
45 portion, in light guiding plate, to which second deflection mechanism is provided
46 optical member
47 first reflective volume-hologram diffraction grating member
48 second reflective volume-hologram diffraction grating member
49 third reflective volume-hologram diffraction grating member
50 observer
51 eyeball (pupil)
61 transparent member
80, 80′ light adjusting apparatus
81 first substrate
82 second substrate
81′, 82′ barrier layer
83 first transparent electrode
84 second transparent electrode
85 moisture holding member
85′ protection layer
86 moisture-holding-member extension
87 sealing member
88 first auxiliary electrode
89 second auxiliary electrode
90 light adjusting layer
91 reduction coloring layer
92 electrolyte layer
93 oxidation coloring layer

1. A display apparatus, comprising:
a frame; and
a right-eye image display apparatus and a left-eye image display apparatus that are attached to the frame,
each of the image display apparatuses including
an image forming apparatus, and
an optical apparatus that guides an image coming from the image forming apparatus to a pupil of an observer,
the optical apparatus including
a light guiding plate,
a first deflection mechanism that is attached to the light guiding plate, and
a second deflection mechanism that is attached to the light guiding plate, wherein
the image coming from the image forming apparatus enters the first deflection mechanism, is deflected by the first deflection mechanism, is guided through the light guiding plate, enters the second deflection mechanism, is deflected by the second deflection mechanism, and enters the pupil of the observer, and
when a central ray that exits from a center point of an image forming region in the image forming apparatus, is deflected by the second deflection mechanism to enter the pupil of the observer, and when a point, on the light guiding plate, at which the central ray exits the light guiding plate is an origin, and when, in an XYZ orthogonal coordinate system of which axes of X, Y, and Z pass through the origin, an axis of the light guiding plate that passes through the origin is an X axis, an axis that passes through the origin and extends in parallel with a normal line of the light guiding plate is a Z axis, and an axis that is orthogonal to the X and Z axes is a Y axis, the central ray enters from a position closer to the image forming apparatus than an imaginary vertical plane that includes a pupillary axis and is parallel to the Y axis.

2. The display apparatus according to claim 1, wherein
α>0 degrees is satisfied when α is an angle formed by the pupillary axis and an orthogonal projection image obtained by orthogonally projecting the central ray onto an XZ plane.

3. The display apparatus according to claim 2, wherein
α≥5 degrees is satisfied.

4. The display apparatus according to claim 2, wherein
α>β is satisfied when 2β is an angle formed by a first-light-ray orthogonal projection image and a second-light-ray orthogonal projection image, the first-light-ray orthogonal projection image being obtained by orthogonally projecting a first light ray onto the XZ plane, the first light ray exiting an ear-side end of the image forming apparatus that is situated in an imaginary XZ plane in the image forming apparatus, and entering the pupil of the observer, the imaginary XZ plane corresponding to the XZ plane, the second-light-ray orthogonal projection image being obtained by orthogonally projecting a second light ray onto the XZ plane, the second light ray exiting a nose-side end of the image forming apparatus that is situated in the imaginary XZ plane, and entering the pupil of the observer.

5. The display apparatus according to claim 1, wherein
0 degrees≤θ₀≤30 degrees is satisfied when an angle formed by the pupillary axis and the normal line of the light guiding plate is θ₀, the normal line passing through an intersection of the pupillary axis and the light guiding plate.

6. The display apparatus according to claim 1, wherein
when the central ray enters the light guiding plate at an angle of incidence θᵢₙ and exits the light guiding plate at an exit angle θₒᵤₜ, the angle of incidence θᵢₙ and the exit angle θₒᵤₜ exhibit the same value, and a direction at the angle of incidence θᵢₙ relative to the light guiding plate and a direction at the exit angle θₒᵤₜ relative to the light guiding plate are different from each other.

7. The display apparatus according to claim 1, wherein
from among light rays exiting the image forming apparatus, a portion of light rays situated on a side of an ear of the observer is not deflected by the first deflection mechanism.

8. The display apparatus according to claim 1, wherein
a slant angle in the first deflection mechanism differs between a region, in the first deflection mechanism, that is situated on a side of an ear of the observer and a region, in the first deflection mechanism, that is situated on a side of a nose of the observer, and
a slant angle in the second deflection mechanism differs between a region, in the second deflection mechanism, that is situated on the side of the nose of the observer and a region, in the second deflection mechanism, that is situated on the side of the ear of the observer.

9. The display apparatus according to claim 1, wherein
an image that exits the image forming apparatus of the right-eye image display apparatus and an image that exits the image forming apparatus of the left-eye image display apparatus are different images.

10. The display apparatus according to claim 1, wherein
an image that exits the image forming apparatus of the right-eye image display apparatus is observed on a side of a right ear of the observer, and an image that exits the image forming apparatus of the left-eye image display apparatus is observed on a side of a left ear of the observer.

11. The display apparatus according to claim 1, wherein
an image that exits the image forming apparatus of the right-eye image display apparatus and an image that exits the image forming apparatus of the left-eye image display apparatus are not fused with each other.

12. A display apparatus, comprising:
a frame; and
a right-eye image display apparatus and a left-eye image display apparatus that are attached to the frame,
each of the image display apparatuses including
an image forming apparatus, and
an optical apparatus that guides an image coming from the image forming apparatus to a pupil of an observer,
the optical apparatus including
a light guiding plate,
a first deflection mechanism that is attached to the light guiding plate, and
a second deflection mechanism that is attached to the light guiding plate, wherein
the image coming from the image forming apparatus enters the first deflection mechanism, is deflected by the first deflection mechanism, is guided through the light guiding plate, enters the second deflection mechanism, is deflected by the second deflection mechanism, and enters the pupil of the observer, and
an image that is formed by the right-eye image display apparatus and an image that is formed by the left-eye image display apparatus are not fused with each other.

13. A display apparatus, comprising:
a frame; and
an image display apparatus that is attached to the frame,
the image display apparatus including
an image forming apparatus, and
an optical apparatus that guides an image coming from the image forming apparatus to a pupil of an observer,
the optical apparatus including
a light guiding plate,
a first deflection mechanism that is attached to the light guiding plate, and
a second deflection mechanism that is attached to the light guiding plate, wherein
the image coming from the image forming apparatus enters the first deflection mechanism, is deflected by the first deflection mechanism, is guided through the light guiding plate, enters the second deflection mechanism, is deflected by the second deflection mechanism, and enters the pupil of the observer, and
when a central ray that exits from a center point of an image forming region in the image forming apparatus, is deflected by the second deflection mechanism to enter the pupil of the observer, and when a point, on the light guiding plate, at which the central ray exits the light guiding plate is an origin, and when, in an XYZ orthogonal coordinate system of which axes of X, Y, and Z pass through the origin, an axis of the light guiding plate that passes through the origin is an X axis, an axis that passes through the origin and extends in parallel with a normal line of the light guiding plate is a Z axis, and an axis that is orthogonal to the X and Z axes is a Y axis, the central ray enters from a position closer to the image forming apparatus than an imaginary vertical plane that includes a pupillary axis and is parallel to the Y axis.

14. An image display apparatus, comprising:
an image forming apparatus; and
an optical apparatus that guides an image coming from the image forming apparatus to a pupil of an observer,
the optical apparatus including
a light guiding plate,
a first deflection mechanism that is attached to the light guiding plate, and
a second deflection mechanism that is attached to the light guiding plate, wherein
the image coming from the image forming apparatus enters the first deflection mechanism, is deflected by the first deflection mechanism, is guided through the light guiding plate, enters the second deflection mechanism, is deflected by the second deflection mechanism, and enters the pupil of the observer, and
when a central ray that exits from a center point of an image forming region in the image forming apparatus, is deflected by the second deflection mechanism to enter the pupil of the observer, and when a point, on the light guiding plate, at which the central ray exits the light guiding plate is an origin, and when, in an XYZ orthogonal coordinate system of which axes of X, Y, and Z pass through the origin, an axis of the light guiding plate that passes through the origin is an X axis, an axis that passes through the origin and extends in parallel with a normal line of the light guiding plate is a Z axis, and an axis that is orthogonal to the X and Z axes is a Y axis, the central ray enters from a position closer to the image forming apparatus than an imaginary vertical plane that includes a pupillary axis and is parallel to the Y axis.
